(19) United States
(12) Patent Application Publication
(10) Pub. No.: US 2026/0277291 A1
(43) Pub. Date: Sep. 17, 2026

(54) VOLTAGE DROOP DETECTION AND MITIGATION CIRCUIT SHARING DELAY LINE, AND CLOCK SUPPLY CIRCUIT INCLUDING THE SAME

(71) Applicant: SAMSUNG ELECTRONICS CO., LTD., Suwon-si (KR)

(72) Inventors: Minyoung KANG, Suwon-si (KR); Dongsuk JEON, Seoul (KR)

(73) Assignees: SAMSUNG ELECTRONICS CO., LTD., Suwon-si (KR); SEOUL NATIONAL UNIVERSITY R&DB FOUNDATION, Seoul (KR)

(21) Appl. No.: 19/566,397

(22) Filed: Mar. 13, 2026

(30) Foreign Application Priority Data
Mar. 13, 2025 (KR) 10-2025-0032942
May 12, 2025 (KR) 10-2025-0061459

(51) Int. Cl. G06F 1/30; G06F 1/324

(52) U.S. Cl. CPC G06F 1/305; G06F 1/324

(57) ABSTRACT

A clock supply circuit includes: a delay line to which a voltage is supplied from a supply voltage line; a clock signal output circuit configured to output one of a first clock signal or a second clock signal corresponding to an input clock signal to a device based on a flag signal, wherein the first clock signal having a first frequency and the second clock signal having a second frequency; a droop detection circuit configured to output the flag signal to the clock signal output circuit, the flag signal indicating whether a droop is detected for the voltage based on a propagation degree of the first clock signal in the delay line; and a droop mitigation circuit configured to output an output selection signal for the delay line to the clock signal output circuit to control the second frequency of the second clock signal.

### CROSS-REFERENCE TO RELATED APPLICATION

This application is based on and claims priority under 35 U.S.C. § 119 to Korean Patent Application No. 10-2025-0032942, filed on Mar. 13, 2025, and Korean Patent Application No. 10-2025-0061459, filed on May 12, 2025, in the Korean Intellectual Property Office, the disclosure of which is incorporated by reference herein in its entirety.

### BACKGROUND

The present disclosure relates to a semiconductor circuit, and more specifically, to a clock supply circuit including a supply voltage droop detection circuit using a delay line and a supply voltage droop mitigation circuit.

In a semiconductor circuit requiring high-speed operation, a droop phenomenon in which a supply voltage drops significantly may occur when power consumption increases rapidly, which may cause the decrease in circuit's response speed, thereby failing to satisfy the timing requirements of the clock signal and causing the circuit to malfunction.

In order to mitigate a supply voltage droop, for example, a clock divider that lowers the frequency of an input clock signal at a set rate and outputs it may be used, and then a clock gating method that blocks the output of the output clock signal and directly provides the input clock signal as an output clock signal again may be utilized. However, because the frequency is adjusted at a set rate, it is difficult to flexibly respond to the degree of a supply voltage droop, and the stability and operation speed of the circuit may be negatively affected in the process of the output clock signal being blocked and then resumed.

Therefore, in order to stably generate and switch clock signals and supply the signals to devices, it may be important to design a clock supply circuit that takes performance and operational stability into consideration.

### SUMMARY

One or more embodiments provide a clock supply circuit for detecting a supply voltage droop and immediately adjusting a clock frequency by using the same delay line for supply voltage droop detection and supply voltage droop mitigation.

According to an aspect of the disclosure, a clock supply circuit includes: a delay line to which a voltage is supplied from a supply voltage line; a clock signal output circuit configured to output one of a first clock signal or a second clock signal corresponding to an input clock signal to a device based on a flag signal, wherein the first clock signal having a first frequency and the second clock signal having a second frequency; a droop detection circuit configured to output the flag signal to the clock signal output circuit, the flag signal indicating whether a droop is detected for the voltage based on a propagation degree of the first clock signal in the delay line; and a droop mitigation circuit configured to output an output selection signal for the delay line to the clock signal output circuit to control the second frequency of the second clock signal.

According to an aspect of the disclosure, a clock supply circuit includes: a clock signal output circuit configured to, based on a flag signal having a first value, output an input clock signal that has passed through a delay line, to which voltage is supplied from a supply voltage line, as a first clock signal; and a droop detection circuit configured to detect a droop in the voltage based on a propagation degree of the first clock signal in the delay line, and to convert the flag signal to a second value, wherein the clock signal output circuit is further configured to, based on the flag signal having the second value, output a second clock signal generated using the delay line.

According to an aspect of the disclosure, a clock supply circuit includes: a clock signal output circuit configured to, based on a flag signal having a first value, output an input clock signal that has passed through a delay line, to which a voltage is supplied from a supply voltage line, as a first clock signal, and based on the flag signal having a second value, output a second clock signal generated using the delay line, wherein the first clock signal is characterized by a first frequency and the second clock signal is characterized by a second frequency; and a droop mitigation circuit configured to output an output selection signal for the delay line to the clock signal output circuit to control the second frequency of the second clock signal to reach a target frequency, wherein the first value indicates non-detection of a droop of the voltage, the second value indicates detection of the droop of the voltage, and the droop mitigation circuit is further configured to switch the flag signal from the second value to the first value based on a phase difference between the input clock signal and the second clock signal having the target frequency being less than a second threshold.

### BRIEF DESCRIPTION OF THE DRAWINGS

The above and/or other aspects will be more clearly understood from the following detailed description taken in conjunction with the accompanying drawings, in which:

FIG. 1 is a block diagram schematically illustrating an electronic device according to an embodiment;

FIG. 2 is a block diagram schematically illustrating a clock supply circuit according to an embodiment;

FIG. 3 is a block diagram illustrating an implementation example of a clock supply circuit according to an embodiment;

FIG. 4 is a block diagram illustrating a flag generator of FIG. 3 according to an embodiment;

FIGS. 5A and 5B are block diagrams illustrating examples of an operation of detecting a droop according to an embodiment;

FIGS. 6A and 6B are circuit diagrams illustrating examples of an operation of generating a clock signal according to an embodiment;

FIG. 7 is a block diagram illustrating a clock stretch control circuit of FIG. 3 according to an embodiment;

FIG. 8 is a block diagram illustrating a frequency control circuit of FIG. 3 according to an embodiment;

FIG. 9 is a timing diagram illustrating an example of an operation of generating a clock signal according to an embodiment;

FIG. 10 is a timing diagram schematically illustrating the function of the alignment verification circuit of FIG. 3 according to an embodiment;

FIG. 11 is a block diagram illustrating the alignment verification circuit of FIG. 3 according to an embodiment;

FIG. 12 is a block diagram illustrating the differentiator of FIG. 11 according to an embodiment;

FIG. 13 is a timing diagram specifically illustrating the operation of FIG. 11 according to an embodiment;

FIG. 14 is a block diagram illustrating the alignment detection circuit of FIG. 11 according to an embodiment;

FIG. 15 is a circuit diagram illustrating the phase comparator of FIG. 14 according to an embodiment; and

FIGS. 16 to 19 are timing diagrams specifically illustrating the operation of FIG. 15 according to an embodiment.

### DETAILED DESCRIPTION

As multiple logic operations are performed within the same time, the instantaneous current consumption increases, which may cause a supply voltage droop. The supply voltage droop refers to a phenomenon in which the supply voltage temporarily drops due to an instantaneous increase in current consumption during the operation of the circuit, which may cause a circuit malfunction. At this time, if the clock frequency is lowered, the total current consumption of the circuit is reduced, and thus, the supply voltage droop may be mitigated or eliminated.

Hereinafter, with reference to the drawings, it will be described that detection of the occurrence of a supply voltage droop, and droop mitigation and resolution operations through adjustment of the clock frequency may be implemented in a single circuit.

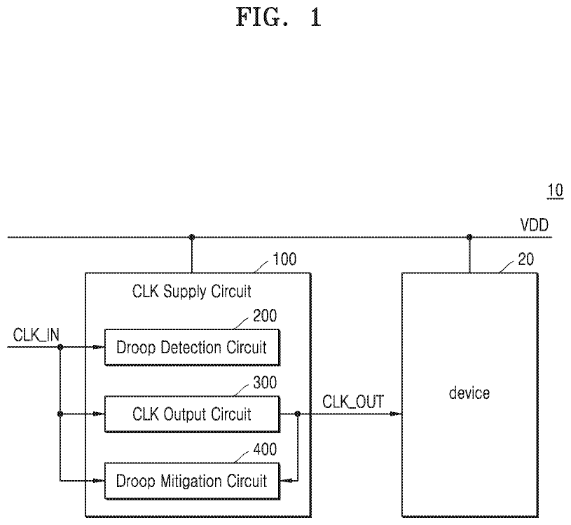

FIG. 1 is a block diagram schematically illustrating an electronic device 10 according to an embodiment.

FIG. 1 illustrates an electronic device 10 according to an embodiment, and the electronic device 10 may further include other clock supply circuits (not shown) and other devices (not shown).

Referring to FIG. 1, the electronic device 10 may include at least one device 20 and a clock supply circuit 100.

The device 20 may receive voltage from the same supply voltage VDD line as the clock supply circuit 100. The device 20 may be various semiconductor integrated circuits such as a central processing unit (CPU), a graphic processing unit (GPU), a system on chip, a memory controller, a display controller, etc., but is not limited thereto and may include external circuits or other digital systems. In addition, depending on the function, area, design method, etc., the device 20 may receive power from the same supply voltage line as at least one other clock supply circuit (not shown).

The clock supply circuit 100 may generate an output clock signal CLK_OUT from an input clock signal CLK_IN. The input clock signal CLK_IN may be a signal provided from a phase-locked loop (PLL), but is not limited thereto, and may be a signal provided from various sources such as a delay-locked loop (DLL), an external clock source, an oscillator, etc. The input clock signal CLK_IN may have a characteristic of low jitter. The input clock signal CLK_IN may be a first clock signal, and the output clock signal CLK_OUT may be a first clock signal or a second clock signal depending on whether a supply voltage droop occurs. For example, when a supply voltage droop occurs, the output clock signal CLK_OUT may correspond to a second clock signal, and the frequency of the second clock signal may be adjusted by the clock supply circuit 100.

The clock supply circuit 100 may include a droop detection circuit 200, a clock signal output circuit 300, and a droop mitigation circuit 400. The droop detection circuit 200 may detect whether a supply voltage droop occurs, and the clock signal output circuit 300 may output one of the first clock signal and the second clock signal as an output clock signal CLK_OUT to the device 20 based on whether a supply voltage droop occurs or not. The droop mitigation circuit 400 may control the clock signal output circuit 300 to generate a second clock signal having a lower frequency than the input clock signal CLK_IN based on the occurrence of a supply voltage droop.

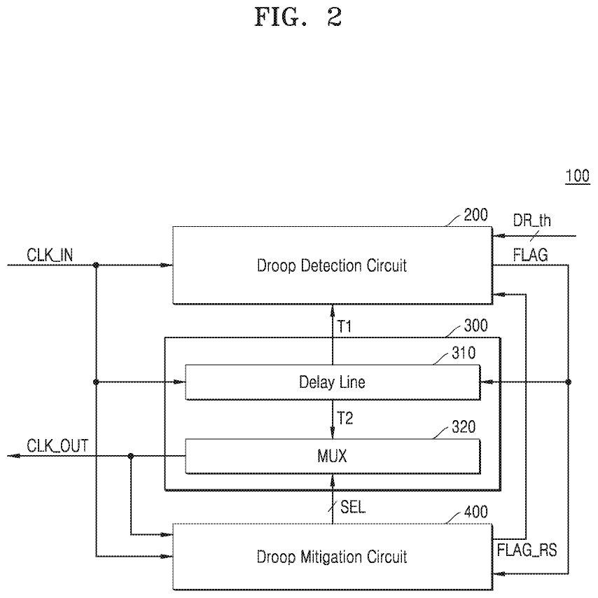

FIG. 2 is a block diagram schematically illustrating the clock supply circuit 100 according to an embodiment.

Referring to FIG. 2, the clock supply circuit 100 may include the droop detection circuit 200, the clock signal output circuit 300, and the droop mitigation circuit 400.

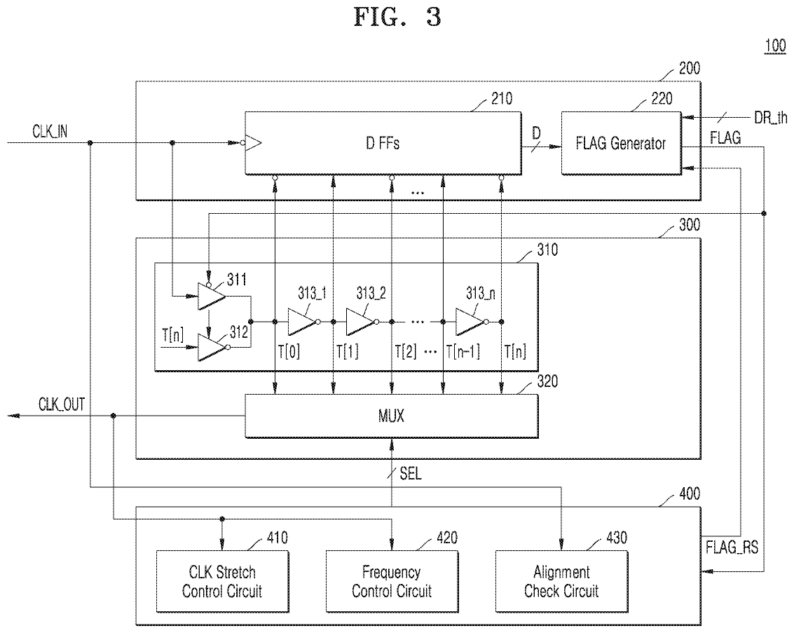

The droop detection circuit 200 may determine whether a droop occurs in the supply voltage based on the propagation degree D (see FIG. 3) of the first clock signal in a delay line 310. Whether a droop occurs may be determined by comparing the propagation degree D (see FIG. 3) of the first clock signal calculated based on the output T1 of the delay line 310 with the first threshold DR_th. In an embodiment, it may be determined that a droop has occurred if the propagation degree D (see FIG. 3) of the first clock signal is less than or equal to the first threshold DR_th. The droop detection circuit 200 may output a flag signal FLAG having a first value to the clock signal output circuit 300 and the droop mitigation circuit 400 based on the occurrence of a droop, and may output a flag signal FLAG having a second value to the clock signal output circuit 300 and the droop mitigation circuit 400 if the droop does not occur. In an embodiment, if the flag signal FLAG has a ‘0’ value (or low level), it may indicate a droop non-detection, and if the flag signal FLAG has a ‘1’ value (or high level), it may indicate a droop detection, but is not limited thereto.

The clock signal output circuit 300 may include the delay line 310 and a multiplexer 320. The clock signal output circuit 300 may output a first clock signal corresponding to the input clock signal CLK_IN as an output clock signal CLK_OUT to the device 20 (see FIG. 1) when the flag signal FLAG indicates droop non-detection, and may output a second clock signal as an output clock signal CLK_OUT to the device 20 (see FIG. 1) when the flag signal FLAG indicates droop detection. The frequency of the second clock signal may be lower than the frequency of the first clock signal. The multiplexer 320 may select an output T2 from the delay line 310 according to the output selection signal SEL and output either the first clock signal or the second clock signal as an output clock signal CLK_OUT to the device (20).

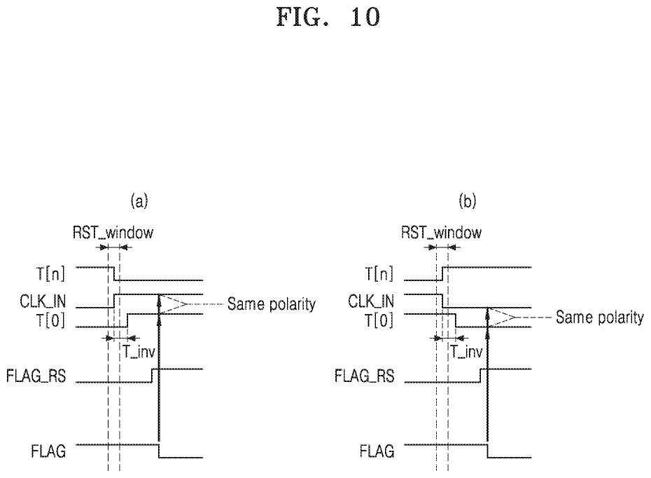

The droop mitigation circuit 400 may generate an output selection signal SEL and output the output selection signal SEL to the multiplexer 320. The droop mitigation circuit 400 may generate an output selection signal SEL for outputting the first clock signal as an output clock signal CLK_OUT when the flag signal FLAG indicates that the droop is not detected, and may generate an output selection signal SEL for controlling the second clock signal to gradually reach the target frequency and outputting it as an output clock signal CLK_OUT when the flag signal FLAG indicates that the droop is detected. A target frequency of the second clock signal may be lower than the frequency of the first clock signal, and the droop mitigation circuit 400 may adjust the target frequency of the second clock signal to gradually increase. The droop mitigation circuit 400 may determine whether the droop is eased and determine whether a phase difference between the input clock signal CLK_IN and the second clock signal having the target frequency is less than a range of a second threshold RST_window, (see FIG. 10). Based on the determination result, a reset signal FLAG_RS for the flag signal may be output to the droop detection circuit 200 so that the flag signal FLAG indicating droop detection is switched to the flag signal FLAG indicating droop non-detection.

FIG. 3 is a block diagram showing an implementation example of a clock supply circuit according to an embodiment.

In an embodiment, the droop detection circuit 200 may include a plurality of D flip-flops 210 and a flag generator 220. The plurality of D flip-flops 210 may be, but are not limited to, falling-edge triggered D flip-flops that capture and output an input signal at a falling edge of an input clock signal CLK_IN. The plurality of D flip-flops 210 may have a structure in which an inverted input type D flip-flop, which is a structure in which an input signal is inverted through an inverter and then provided as an input, and a non-inverted input type D flip-flop, which is a structure in which an input signal is directly provided as a D input without inversion, are alternately arranged, but are not limited thereto.

The plurality of D flip-flops 210, at the falling edge of the input clock signal CLK_IN, may capture first to n+1^{th} signals (T[0] to T[n]) output from first to n+1^{th} nodes of the delay line 310 to which the input clock signal CLK_IN is input, and may output the propagation degree D of the input clock signal CLK_IN to the flag generator 220. The propagation degree D of the input clock signal CLK_IN may be a thermometer code, but is not limited thereto. The flag generator 220 my compare the propagation degree D of the input clock signal CLK_IN with the first threshold DR_th, and output a flag signal FLAG indicating droop detection when the propagation degree D of the input clock signal CLK_IN is less than or equal to the first threshold DR_th. The first threshold DR_th may be set to a one-hot code, but is not limited thereto.

The clock signal output circuit 300 may include the delay line 310 and the multiplexer 320. The clock signal output circuit 300 may output a first clock signal corresponding to the input clock signal CLK_IN based on a flag signal FLAG indicating whether a droop is detected, if the flag signal (FLAG) indicates that the droop is not detected, and may generate and output a second clock signal if the flag signal FLAG indicates that the droop is detected. As an example, the first clock signal may correspond to an input clock signal CLK_IN delayed by the delay line 310.

Specifically, when the flag signal FLAG indicates a non-detection of droop, the first node of the delay line 310 to which the input clock signal CLK_IN is input may be selected by the multiplexer 320, and thus, a first signal T[0] signal may be output as the output clock signal CLK_OUT, and the first signal T[0] signal may be referred to as the first clock signal. At this time, the first clock signal, which is the output clock signal CLK_OUT, may have a characteristic of low temporal variation (low jitter).

When the flag signal FLAG indicates droop detection, the multiplexer (320 may sequentially select some of the first to n+1^{th} signals T[0] to T[n] output from the delay line 310 to which the input clock signal (CLK_IN) is input based on the output selection signal SEL. The signals selected by the multiplexer 320 may constitute a second clock signal, and the second clock signal may be output as an output clock signal CLK_OUT. At this time, the second clock signal, which is the output clock signal CLK_OUT, may have a lower frequency than the first clock signal.

The delay line 310 may include a plurality of inverters 313_1 to 313_n, a tri-state buffer 311, and a tri-state inverter 312. The delay line 310 is not limited thereto and may include other elements that serve to delay the clock signal. In an embodiment, the droop detection circuit 200 and the droop mitigation circuit 400 may share the delay line 310.

The delay line 310 may operate in a mode for detecting a voltage droop and a mode for mitigating a voltage droop based on a flag signal FLAG. That is, the delay line 310 may operate in a mode for detecting a voltage droop by the droop detection circuit 200 and in a mode for mitigating a voltage droop by the droop mitigation circuit 400.

When the flag signal FLAG indicates non-detection of a droop, the delay line 310 may operate in a mode for detecting a voltage droop. In this case, the delay line 310 may transmit a first clock signal corresponding to the input clock signal CLK_IN to a plurality of inverters 313_1 to 313_n by activating the tri-state buffer 311 and deactivating the tri-state inverter 312. The fact that the first clock signal matches the input clock signal CLK_IN may denote that the input clock signal CLK_IN may mean that a signal passing through at least one of the plurality of inverters 313_1 to 313_n of the delay line 310 is the first clock signal. Based on the propagation degree D of the first clock signal, the droop detection circuit 200 may determine whether a voltage droop occurs.

If the flag signal FLAG indicates droop detection, the delay line 310 may operate in a mode that mitigates the voltage droop. In this case, the delay line 310 may activate the tri-state inverter 312 and deactivate the tri-state buffer 311 so that the plurality of inverters 313_1 to 313_n and the tri-state inverter 312 form a ring oscillator. The ring oscillator forms a closed loop path including the plurality of inverters 313_1 to 313_n and the tri-state inverter 312, along which a first clock signal may circulate. The delay line 310 may provide the first to n+1^{th} signals T[0] to T[n] output from the plurality of inverters 313_1 to 313_n and the tri-state inverter 312 forming the ring oscillator as inputs to the multiplexer 320. The multiplexer (320) may output the second clock signal as an output clock signal CLK_OUT by sequentially selecting some of the first to n+1^{th} signals T[0] to T[n] based on an output selection signal SEL provided from the droop mitigation circuit 400.

The droop mitigation circuit 400 may include a clock stretch control circuit 410, a frequency control circuit 420, and an alignment check circuit 430.

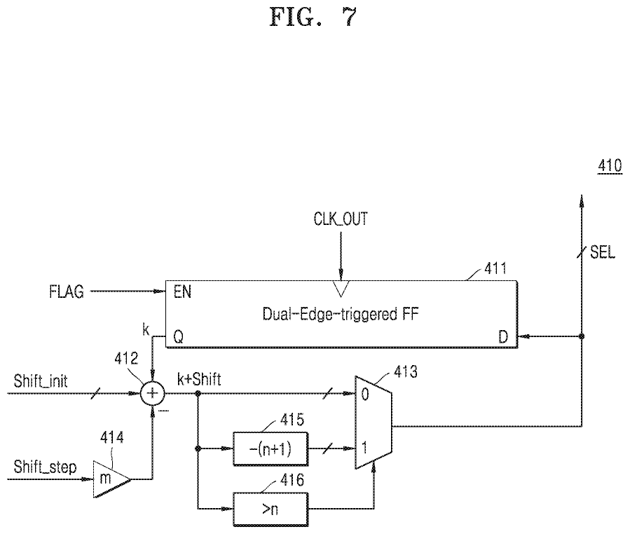

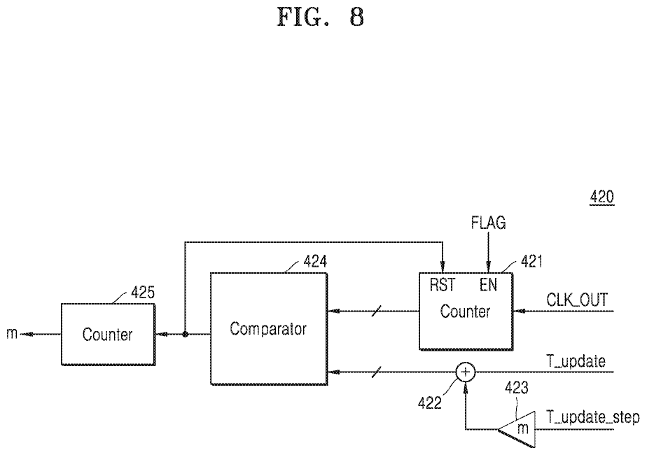

The clock stretch control circuit 410 and the frequency control circuit 420 may generate an output selection signal SEL to be provided to the multiplexer 320. The specific operation of the clock stretch control circuit 410 and the frequency control circuit 420 will be described later with reference to FIGS. 7 and 8.

The alignment check circuit 430 determines whether the droop is eliminated, determines whether the phase difference between the input clock signal CLK_IN and the second clock signal is less than the range of the second threshold RST_window, and outputs a reset signal FLAG_RS to the droop detection circuit 200 so that the flag signal FLAG indicating the droop detection is switched (or initialized) to the flag signal FLAG indicating the droop non-detection. The specific operation of the alignment check circuit 430 is described later with reference to FIGS. 10 to 16B.

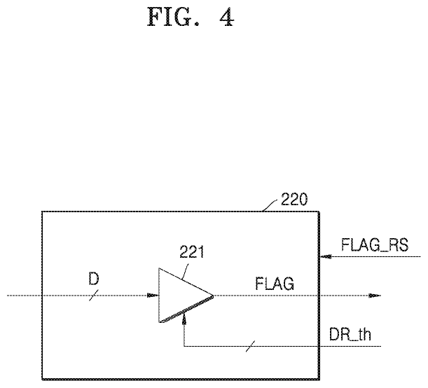

FIG. 4 is a block diagram showing a flag generator 220 of FIG. 3 according to an embodiment.

The flag generator 220 may compare the propagation degree D of the first clock signal with the first threshold DR_th and if the propagation degree D of the first clock signal is less than or equal to the first threshold DR_th, output a flag signal FLAG indicating droop detection. When a reset signal FLAG_RS indicating that the droop is resolved is input from the droop mitigation circuit 400, the flag signal FLAG having a second value indicating droop detection may be converted to a flag signal FLAG having a first value indicating droop non-detection. When a value of ‘0’ is output as the flag signal FLAG, droop non-detection may be indicated, and when a value of ‘1’ is output as the flag signal FLAG, droop detection may be indicated, but is not limited thereto.

Specifically, in a situation when a flag signal FLAG indicating droop non-detection is output (for example, a flag signal FLAG with a value of ‘0’ is output), if the propagation degree D of the first clock signal is lower than or equal to the first threshold DR_th, a flag signal FLAG indicating droop detection may be output (for example, a flag signal FLAG with a value of ‘1’ is output). In a situation when a flag signal FLAG indicating droop detection is output (for example, a flag signal FLAG with a value of ‘1’ is output), if a reset signal FLAG_RS indicating that droop is eased is received from the droop mitigation circuit 400, a flag signal FLAG indicating droop non-detection may be output (for example, a flag signal FLAG with a value of ‘0’ is output).

The flag generator 220 may include a tri-state buffer 221. The tri-state buffer 221 may use the propagation degree D of the first clock signal as input, use the first threshold DR_th as a control signal, and output a flag signal FLAG.

The first threshold DR_th may be set to a one-hot code. The first threshold DR_th set to a one-hot code may have a value of ‘1’ for only a specific bit among a plurality of bits, and the tri-state buffer 221 may be activated only for the specific bit having the value of ‘1’. At this time, if the bit of the propagation degree D of the first clock signal of the same index as the index where the specific bit is located has a value of ‘1’, the value of ‘1’ may be output as the flag signal FLAG, and if the bit of the propagation degree D of the first clock signal of the same index as the index where the specific bit is located has a value of ‘0’, the value of ‘0’ may be output as the flag signal FLAG. That is, because only a specific bit among multiple bits is used to output the flag signal FLAG indicating whether or not a droop is detected, the droop in the supply voltage may be detected quickly, thereby reducing the time required for droop detection (droop detection latency).

For example, the propagation degree D of the first clock signal includes 7 bits [6:0], has a value of ‘1100000’ when no voltage droop occurs, and has a value of ‘1110000’ when a voltage droop occurs. The propagation degree D of the first clock signal with a value of ‘1100000’ may be seen as the bit [0] corresponding to the first significant digit (i.e., the least significant bit (LSB) is ‘0’, the bit [1] corresponding to the second significant digit is ‘0’, the bit [2] corresponding to the third significant digit is ‘0’, the bit [3] corresponding to the fourth significant digit is ‘0’, the bit [4] corresponding to the fifth significant digit is ‘0’, the bit [5] corresponding to the sixth significant digit is ‘1’, and the bit [6] corresponding to the seventh significant digit (i.e., the most significant bit (MSB)) is ‘1’. The propagation degree D of the first clock signal with a value of ‘1100000’ may be interpreted as being greater than the propagation degree D of the first clock signal with a value of ‘1110000’, and the propagation degree D of the first clock signal may be reduced due to the occurrence of a voltage droop. The first threshold DR_th includes 7 bits [6:0], and may have the value ‘0010000’ in which only the bit [4] corresponding to the fifth significant digit among the 7 bits is ‘1’, and the other bits are ‘0’. If a value of the bit [4] corresponding to the fifth significant digit that is a position of a specific bit having a value of ‘1’ in the first threshold DR_th among the 7 bits of the propagation degree D of the first clock signal is ‘1’, the value of ‘1’ may be output as a flag signal FLAG, and if the value of the bit [4] is ‘0’, the value of ‘0’ may be output as a flag signal FLAG. The propagation degree D of the first clock signal with a value of ‘1100000’ may output a value of ‘O’ as a flag signal FLAG because the value of D[4] is ‘0’, and the propagation degree D of the first clock signal with a value of ‘1110000’ may output the value of ‘1’ as a flag signal FLAG because the value of D[4] is ‘1’.

As another example, the propagation degree D of the first clock signal includes 101 bits [100:0], the first threshold DR_th includes 101 bits [100:0], and only the bit [77] corresponding to the 78^{th} significant digit among the 101 bits [100:0] of the first threshold DR_th may be ‘1’, and the other bits may be ‘0’. At this time, if the bit [77] corresponding to the 78^{th} significant digit among the 101 bits of the propagation degree D of the first clock signal is ‘1’, the value ‘1’ may be output as the flag signal FLAG, and if the bit [77] is ‘0’, the value ‘0’ may be output as the flag signal.

In an embodiment, the flag generator 220 of FIG. 4 illustrates an operation of outputting a flag signal FLAG using the tri-state buffer 221, but is not limited thereto, and may be implemented to achieve the same purpose using other circuit components such as logic gates, multiplexers, comparators, etc.

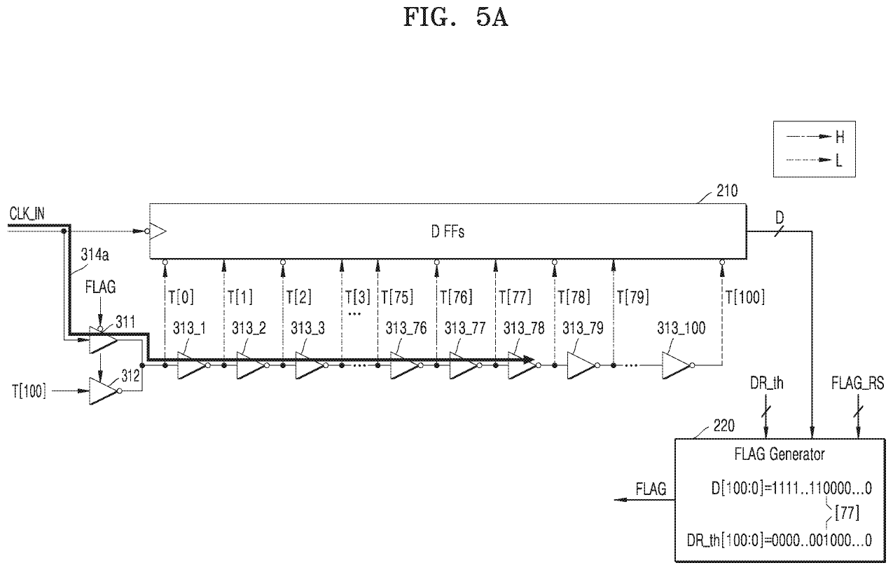

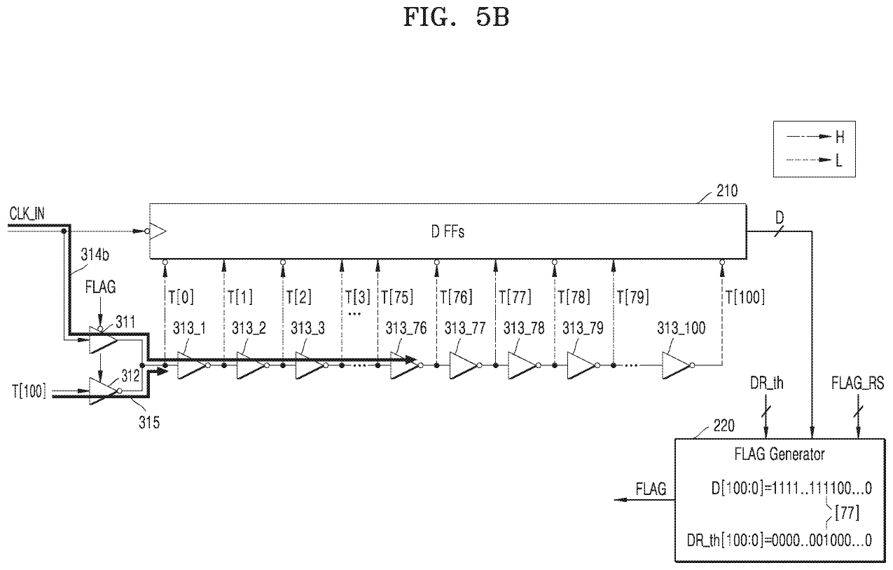

FIGS. 5A and 5B are block diagrams showing examples of an operation of detecting a droop according to an embodiment.

Specifically, FIGS. 5A and 5B are diagrams for explaining a process of determining whether a voltage droop occurs in the delay line 310 and the droop detection circuit 200 and generating a flag signal FLAG. FIG. 5A illustrates the operation of the droop detection circuit 200 and the delay line 310 when a voltage droop does not occur, and FIG. 5B illustrates the operation of the droop detection circuit 200 and the delay line 310 when a voltage droop occurs.

The delay line 310 may include the tri-state buffer 311, a plurality of inverters 313_1 to 313_100, and the tri-state inverter 312, and the droop detection circuit 200 may include the plurality of D flip-flops 210 and the flag generator 220.

The plurality of inverters 313_1 to 313_100 may have a characteristic of causing a constant propagation delay whenever the input clock signal CLK_IN passes through each inverter as a first clock signal due to the driving capability of the transistor and the electrostatic capacitance connected to an output node. When a supply voltage droop occurs, power supply may be temporarily reduced in the plurality of inverters 313_1 to 313_100 that receive power from the same supply voltage VDD line (see FIG. 1) as the device 20 (see FIG. 1), and as a result, the propagation delay of the first clock signal may increase in at least one inverter among the plurality of inverters 313_1 to 313_100. That is, if a supply voltage droop occurs, the propagation delay of the first clock signal may increase, and thus, the propagation degree D of the first clock signal may decrease. The propagation degree D of the first clock signal may denote the number of inverters through which the first clock signal may be propagated during a half clock cycle of the input clock signal CLK_IN. If the propagation degree D of the first clock signal becomes less than or equal to the first threshold DR_th due to an increase in the propagation delay in the inverter, the flag generator 220 may determine that a supply voltage droop has occurred. The first threshold DR_th may denote the threshold of the number of inverters through which the first clock signal may be propagated during the half clock cycle of the input clock signal CLK_IN when the supply voltage droop does not occur. The first threshold DR_th may be arbitrarily set according to the characteristics of the circuit. If it is determined that the supply voltage droop has occurred, the flag generator 220 may output a flag signal FLAG indicating droop detection to the clock signal output circuit 300 (see FIG. 3) and the droop mitigation circuit 400 (see FIG. 3).

To facilitate understanding, hereinafter, as an example, a case in which the number of inverters 313_1 to 313_100 constituting the delay line 310 is 100 and the first threshold DR_th is set to 77 is described, but the embodiment is not limited thereto, and the above numerical values may be variously changed.

Hereinafter, an operation process according to an embodiment will be specifically described with reference to FIG. 5A.

Because the initial flag signal FLAG may be set to a signal indicating droop non-detection (e.g., ‘0’), the tri-state buffer 311 may be activated and the tri-state inverter 312 may be deactivated. The input clock signal CLK_IN as a first clock signal may be propagated along a path 314a passing through the tri-state buffer 311 and the plurality of inverters 313_1 to 313_100 connected in series. The first clock signal may be propagated along the path 314a, and the first to n+1^{th} signals T[0] to T[100] delayed according to the propagation delay of each inverter may be output to the plurality of D flip-flops 210, respectively. The plurality of D flip-flops 210 may capture the first to n+1^{th} signals T[0] to T[100] at a falling edge of the input clock signal CLK_IN and output the propagation degree D of the first clock signal to the flag generator 220.

The propagation degree D of the first clock signal may include 101 bits in an embodiment, and D[100:0] may be a thermometer code in the form of consecutive ‘1’ values followed by consecutive ‘0’ values. The propagation degree D of the first clock signal may be quantitatively expressed based on the index of the bit where the ‘1’ value first appears. For example, when D[6:0]=1110000, the propagation degree D of the first clock signal may be expressed as 4, which is the index of D[4] where the ‘1’ value first appears. In an embodiment, when D[100:0]=1111 . . . 110000 . . . 0, D[77:0] is a ‘0’ value, and because a ‘1’ value appears first in D[78], the propagation degree D of the first clock signal may be expressed as 78. At this time, because the propagation degree D of the first clock signal denotes the number of inverters through which the first clock signal may be propagated during a half clock period of the input clock signal CLK_IN, the number of inverters through which the first clock signal may be propagated during the half clock period of the input clock signal (CLK_IN) is 78.

The first threshold DR_th may be a one-hot code in which only a specific bit among the plurality of bits has a ‘1’ value and the remaining bits have a ‘0’ value. One-hot codes may be expressed quantitatively based on an index of the bits that are ‘1’. For example, if DR_th[6:0]=0010000, it may be expressed as 4, which is the index of DR_th[4] that is ‘1’. In an embodiment, if DR_th[100:0]=0000 . . . 001000 . . . 0, if only D[77] is ‘1’, the first threshold DR_th may be expressed as 77. At this time, the first threshold DR_th means the threshold of the number of inverters through which the first clock signal may be propagated during a half clock period of the input clock signal CLK_IN when the supply voltage droop does not occur, and thus, this may mean that the threshold of the number of inverters through which the first clock signal may be propagated during the half clock period of the input clock signal CLK_IN when the supply voltage droop does not occur is 77.

Because the propagation delay increase in the inverter does not occur when the voltage droop does not occur, the propagation degree D of the first clock signal may exceed the first threshold DR_th. The flag generator 220 may output a bit (e.g., D[77]) of the first clock signal propagation degree D having the same index as the index of the bit (e.g., 77) that is a ‘1’ value in the first threshold DR_th as a flag signal FLAG. The specific operation of the flag generator 220 has been described above in the description with reference to FIG. 4. In the embodiment, the propagation degree D of the first clock signal is D[100:0]=1111 . . . 110000 . . . 0, and because D[77] is a ‘0’ value, a ‘0’ value may be output as a flag signal FLAG, which means droop non-detection.

Hereinafter, the operation process according to the embodiment will be described with reference to FIG. 5B.

Because the operation of the droop detection circuit 200 and the delay line 310 in FIG. 5B is substantially the same as the operation described above with reference to FIG. 5A, the overlapping descriptions thereof will be omitted.

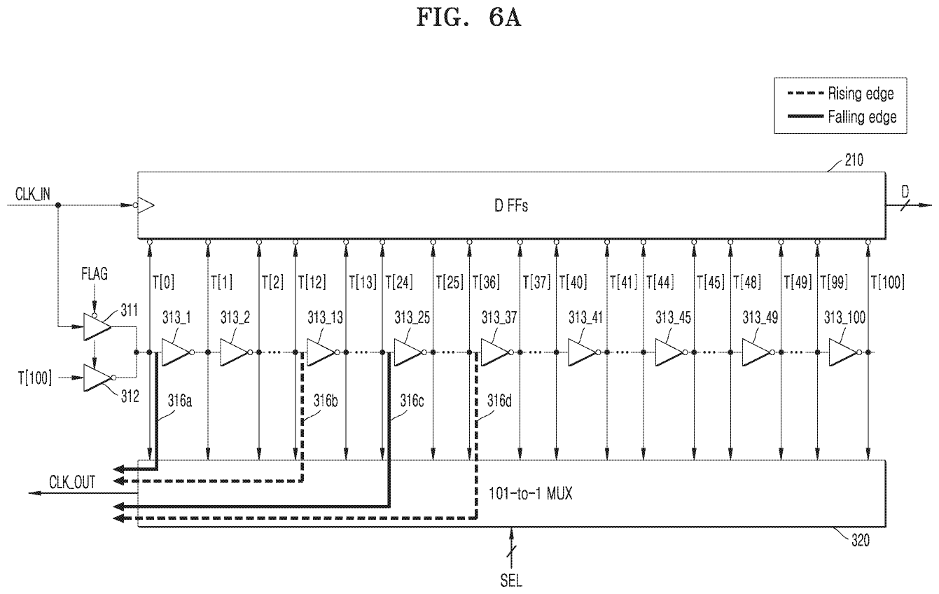

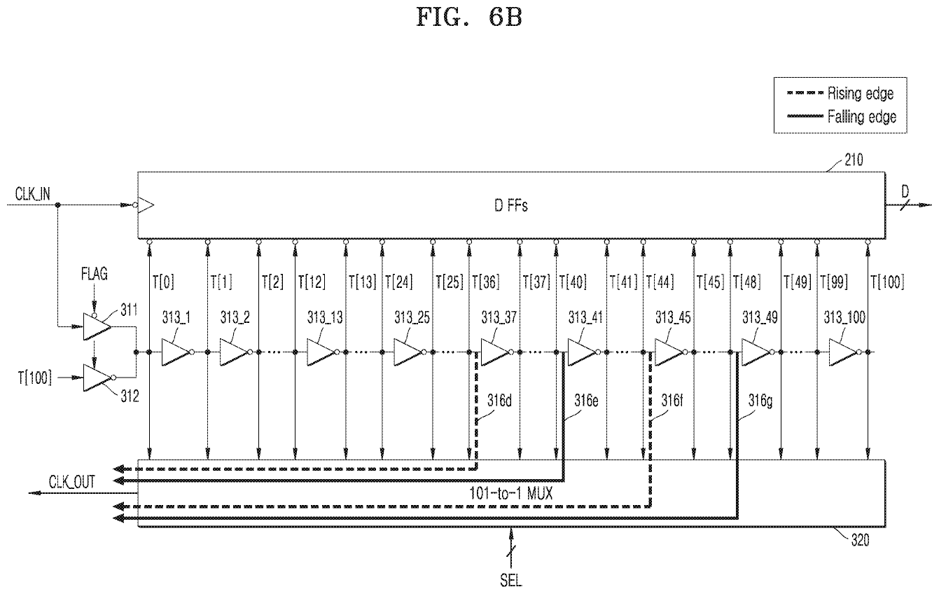

When a voltage droop occurs, the propagation delay of the first clock signal may increase in at least one inverter among the plurality of inverters 313_1 to 313_100, so the propagation degree D of the first clock signal may become lower than the first threshold DR_th. In an embodiment, the propagation degree D of the first clock signal is D[100:0]=1111 . . . 111100 . . . 0 due to the occurrence of a voltage droop, D[75:0] is a ‘0’ value, and because a ‘1’ value first appears in D[76], and thus, the propagation degree D of the first clock signal may be expressed as 76. Because this is less than or equal to 77, which is the first threshold DR_th, the flag generator 220 may output a flag signal FLAG indicating droop detection. Because D[77] is a ‘1’ value, a ‘1’ value may be output as the flag signal FLAG, which may denote droop detection. When the value ‘1’ is output as the flag signal FLAG, the tri-state buffer 311 is deactivated and the tri-state inverter 312 is activated, thus, the path 314b in the delay line 310 is blocked and a path 315 may be activated. The path 315 may be a cyclic path of a closed loop structure of a ring oscillator formed by the plurality of inverters 313_1 to 313_100 and the tri-state inverter 312. When the path 315 is activated, the first clock signal is propagated along the cyclic path 315, and the second clock signal may be output as an output clock signal CLK_OUT, and the specific operation thereof will be described later with reference to FIGS. 6A and 6B.

FIGS. 6A and 6B are circuit diagrams showing examples of operations for generating a clock signal according to an embodiment.

FIG. 6A and FIG. 6B illustrate specific examples of operations for generating a second clock signal having a target frequency in the delay line 310.

When a droop is detected, a second clock signal having a low target frequency may be generated to alleviate the droop, and the target frequency may be increased stepwise considering that the droop will be gradually mitigated. FIG. 6A illustrates an example of an operation for generating a second clock signal having a low target frequency to alleviate the droop, and FIG. 6B illustrates an example of an operation for generating a second clock signal by increasing the target frequency stepwise considering that the droop will be mitigated.

When the flag signal FLAG is switched to a state indicating droop detection, the plurality of inverters 313_1 to 313_100 and the tri-state inverter 312 of the delay line 310 may form a ring oscillator, and a second clock signal having a target frequency may be generated by sequentially selecting some of the outputs of the plurality of inverters 313_1 to 313_100, 312 forming the ring oscillator.

When the flag signal FLAG is in a droop non-detection state, the first clock signal is output as the first signal T[0] output from the first node along a path 316a as an output clock signal CLK_OUT, and when the flag signal FLAG switches to a state indicating droop detection, the second clock signal may be generated by alternately selecting the falling edge and the rising edge of the signal output from the node corresponding to the output selection signal SEL based on the output selection signal SEL output from the droop mitigation circuit 400 (see FIG. 3), and the second clock signal may be output as the output clock signal CLK_OUT. For example, if the output selection signal SEL is calculated as 16, the second clock signal may be generated by selecting either the falling edge or the rising edge of the 17th signal T[16] output from the 17th node.

The output selection signal SEL may be calculated using Equation 1.

SEL=mod(k+Shift,n+1) [Equation 1]

The output selection signal SEL may be produced through modulo operation. That is, the output selection signal SEL may be calculated as the remainder of dividing a value obtained by adding the shift signal Shift (see FIG. 7) to the index k (see FIG. 7) of the current output node by the total number (n+1) of inverters constituting the ring oscillator.

The index k (see FIG. 7) of the current output node may be, for example, 16 when the falling edge of the 17^{th} signal T[16] is being output as the second clock signal in the current 17^{th} node.

The shift signal Shift (see FIG. 7) is a value that determines the half clock period of the second clock signal to be generated, which may represent the number of inverters on the cyclic path through which the first clock signal is propagated within the ring oscillator during the half clock period of the second clock signal. Accordingly, as the value of the shift signal Shift (see FIG. 7) increases, the first clock signal propagates through more inverters, and the propagation delay is accumulated in this process increases, and thus, an interval between the falling edge and the rising edge of the second clock signal increases, and the period of the second clock signal may be controlled to be long.

If a droop is detected, in order to alleviate the droop, the second clock signal may be generated to have a lower target frequency than the first clock signal, that is, a longer target period, and for this purpose, the shift signal Shift (see FIG. 7) may have a value greater than the first threshold DR_th.

The shift signal Shift (see FIG. 7) may be a value obtained by subtracting the value obtained by multiplying the frequency control signal m (see FIGS. 7 and 8) by the shift step signal Shift_step (see FIG. 7) from the initial shift signal Shift_init (see FIG. 7). The shift step signal Shift_step (see FIG. 7) may be a signal that gradually increases the target frequency of the second clock signal, that is, gradually decreases the half clock period of the second clock signal. The frequency control signal m (see FIGS. 7 and 8) may be an integer greater than or equal to 0, and may increase according to an update signal T_update (see FIG. 8) and the update step signal T_update_step (see FIG. 8) in order to gradually increase the target frequency of the second clock signal. As the frequency control signal m (see FIGS. 7 and 8) increases, the shift signal Shift (see FIG. 7) may be gradually reduced, and accordingly, the target frequency of the second clock signal may be gradually increased. The specific operation is described later with reference to FIGS. 7 and 8.

To facilitate understanding, hereinafter, a non-limiting example in which the initial shift signal Shift_init (see FIG. 7) is set to 113 and the shift step signal Shift_step (see FIG. 7) is set to 8 is described below; the above values may be variously changed.

Hereinafter, an operation for generating a second clock signal having a low target frequency will be described with reference to FIG. 6A.

When the flag signal FLAG is switched to a state indicating droop detection, the droop mitigation circuit 400 (see FIG. 3) may output an output selection signal SEL as a selection signal of the multiplexer 320. Since the initial shift signal Shift_init (see FIG. 7) is 113 and the initial frequency control signal m (see FIGS. 7 and 8) is 0, the shift signal Shift (see FIG. 7) may be calculated as 113−8*0=113. The current output signal is the first signal T[0], and accordingly, the index of the current output node k (see FIG. 7) is 0, the shift signal Shift (see FIG. 7) is 113, and the total number of inverters n+1 constituting the ring oscillator is 101, so the output selection signal SEL may be calculated as mod(0+113, 101)=12 according to Equation 1. According to the calculated output selection signal SEL, the 13^{th} signal T[12] output from the 13^{th} node may be output as the first rising edge of the second clock signal through a path 316b.

Then, the output selection signal SEL may be generated as mod(12+113, 101)=24, and according to the calculated output selection signal SEL, the 25^{th} signal T[24] output from the 25^{th} node may be output as the first falling edge of the second clock signal through a path 316c.

Then, the output selection signal SEL may be calculated as mod(24+113, 101)=36, and according to the calculated output selection signal SEL, the 37^{th} signal T[36] output from the 37^{th} node may be output as the second rising edge of the second clock signal through a path 316d.

Hereinafter, referring to FIG. 6B, an operation of generating a second clock signal by gradually increasing the target frequency is described.

In order to gradually increase the target frequency, the frequency control signal m (see FIGS. 7 and 8) may be gradually increased to lower the shift signal Shift (see FIG. 7). FIG. 6B shows a case when the frequency control signal m (see FIGS. 7 and 8) increases to 1. Because the initial shift signal Shift_init (see FIG. 7) is 113 and the frequency control signal m (see FIGS. 7 and 8) is 1, the shift signal Shift (see FIG. 7) may be calculated as 113−8*1=105. The current output signal is the 37^{th} signal T[36], and accordingly, the index k (see FIG. 7) of the current output node is 36, the shift signal Shift (see FIG. 7) is 105, and the total number of inverters n+1 constituting the ring oscillator is 101, so the output selection signal (SEL) may be calculated as mod(36+105, 101)=40 according to Equation 1. According to the calculated output selection signal SEL, the 41st signal T[40] output from the 41st node may be output as the second falling edge of the second clock signal through a path 316e.

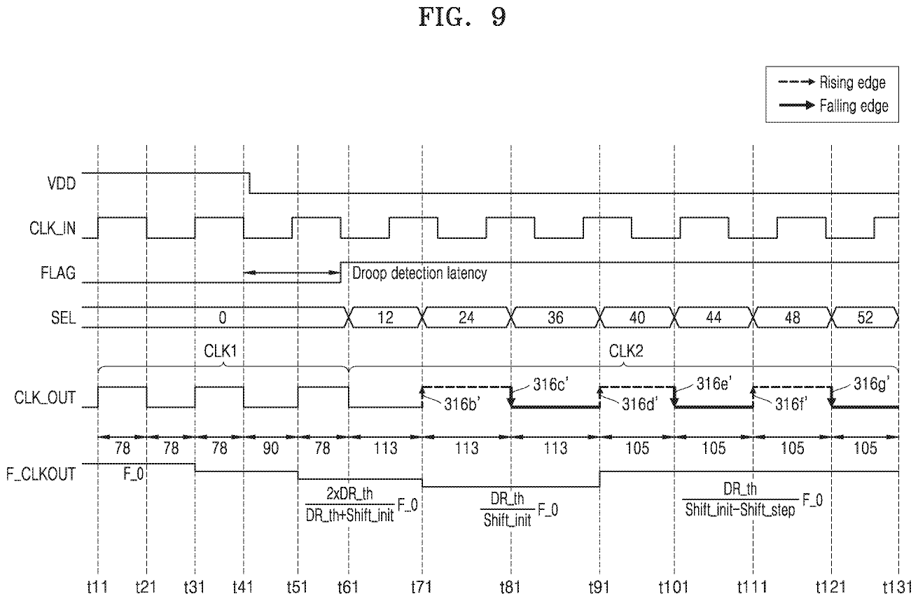

Then, the output selection signal SEL may be generated as mod(40+105, 101)=44, and the 45^{th} signal T[44] output from the 45^{th} node according to the generated output selection signal SEL may be output as a third rising edge of the second clock signal through a path 316f. Then, the output selection signal SEL may be generated as mod(44+105, 101)=48, and the 49^{th} signal T[48] output from the 49^{th} node according to the generated output selection signal SEL may be output as a third falling edge of the second clock signal through the path 316f. A specific timing diagram of the second clock signal generated according to FIGS. 6A and 6B is illustrated in FIG. 9 and will be described later.

FIGS. 7 and 8 are example circuit diagrams for implementing the operations of FIGS. 6A and 6B.

FIG. 7 is a block diagram showing the clock stretch control circuit 410 of FIG. 3 according to an embodiment.

The clock stretch control circuit 410 is activated by a flag signal FLAG indicating droop detection, and may generate an output selection signal SEL for generating a second clock signal by sequentially selecting some of the outputs of the plurality of inverters 313_1 to 313_n, and 312 of FIG. 3 of the delay line 310 and output the output selection signal SEL to the delay line 310 of FIG. 3.

The clock stretch control circuit 410 of FIG. 7 may be a circuit for generating an output selection signal SEL based on the Equation 1 presented in the description of FIG. 6A and FIG. 6B. The clock stretch control circuit 410 is not limited to the example illustrated in FIG. 7, and may be implemented in various ways within the technical scope of the embodiments.

In an embodiment, the clock stretch control circuit 410 may include a dual edge triggered flip-flop 411, an adder/subtractor 412, a multiplexer 413, a multiplier 414, a subtractor 415, and a comparator 416, and the calculation of the Equation 1 may be performed by this configuration.

The dual edge triggered flip-flop 411 may capture the output selection signal SEL, which is input data, at both the rising edge and falling edge of the second clock signal, which is the output clock signal CLK_OUT, and output the captured output selection signal SEL to the adder/subtractor 412, and the corresponding output value may denote the index k of the current output node in Equation 1.

The multiplier 414 may multiply a shift step signal Shift_step by the frequency control signal m and output the product to the adder/subtractor 412, and the adder/subtractor 412 may subtract a value output through the multiplier 414 from an initial shift signal Shift_init to produce a shift signal Shift, and output a value obtained by adding the shift signal Shift to the index k of the current output node to the multiplexer 413.

A value produced by the adder/subtractor 412 may be input to a first input of the multiplexer 413, and a value obtained by subtracting the total number n+1 of inverters constituting the ring oscillator from the value produced by the adder/subtractor 412 may be input to a second input.

The comparator 416 may determine whether the value produced by the adder/subtractor 412 is greater than the number n of the plurality of inverters 313_1 to 313_n (see FIG. 3), and if the value is less than or equal to n, the first input of the multiplexer 413 may be output as an output selection signal SEL, and if the value is greater than n, the second input of the multiplexer 413 may be output as an output selection signal SEL.

For example, in the case when 12 is output as an output selection signal SEL in FIG. 6A and the 13^{th} signal T[12] output from the 13^{th} node is output as the first rising edge of the second clock signal, a process in which 12 is output as the output selection signal SEL will be described. When the number n of multiple inverters 313_1, . . . , 313_n is 100, the initial shift signal Shift_init is 113, the shift step signal Shift_step is 8, the initial frequency control signal m is 0, and the initial output selection signal SEL is 0, the dual edge triggered flip-flop 411 may capture 0 which is the initial output selection signal SEL and output the captured value 0 to the adder/subtractor 412 as the index k of the current output node. The multiplier 414 may output 0, which is calculated by multiplying 8, which is a shift step signal Shift_step, by 0, which is an initial frequency control signal m, to the adder/subtractor 412, and the adder/subtractor 412 may output 113, which is a shift signal Shift calculated by subtracting 0, which is output through the multiplier 414, from 113, which is an initial shift signal Shift_init, and may output 113, which is a value obtained by adding 113, which is a shift signal Shift, and 0, which is an index k of the current output node, to the multiplexer 413. Because 113 is greater than 100, which is the number n of multiple inverters 313_1 to 313_n, FIG. 3, the multiplexer 413 may output 12, which is a value obtained by subtracting 101 from 113, as an output selection signal SEL.

FIG. 8 is a block diagram showing the frequency control circuit 420 of FIG. 3 according to an embodiment.

The frequency control circuit 420 is activated when there is a flag signal FLAG indicating droop detection, and may generate and output a frequency control signal m for controlling the target frequency of the second clock signal to be increased stepwise. The frequency control circuit 420 is not limited to the example illustrated in FIG. 8, and may be implemented in various ways within the technical concept of the embodiments.

In an embodiment, the frequency control circuit 420 may include a counter 421, an adder 422, a multiplier 423, a comparator 424, and a counter 425, and the frequency control signal m may be generated by this configuration.

The frequency control signal m may be an integer greater than or equal to 0, and may be increased stepwise to increase the target frequency of the second clock signal stepwise. Specifically, the frequency control signal (m) may increase when the period of the second clock signal elapses by the number of times obtained by adding to the update signal T_update a product of the update step signal T_update_step and the current frequency control signal (m). The update signal T_update and the update step signal T_update_step may be arbitrarily set, and the degree to which the target frequency of the second clock signal increases stepwise may vary depending on the set value.

The counter 421 may measure how many times the cycle of the second clock signal, which is the output clock signal CLK_OUT, has elapsed and output the number of elapsed times to the comparator 424. The multiplier (423) may output a value obtained by multiplying the update step signal T_update_step and the current frequency control signal m to the adder 422, and the adder 422 may add the update signal T_update to the output value of the multiplier 423 and output the added value to the comparator 424. The comparator 424 compares the number of elapsed cycles of the second clock signal, which is the output value of the counter 421, with a value obtained by adding to the update signal T_update, which is the output value of the adder 422, a product of the update step signal T_update_step and the current frequency control signal m, and if the two values match, resets the counter 421 and outputs an activation signal to the counter 425. The counter 425 may increase the frequency control signal m by 1 and output the frequency control signal whenever the counter 425 receives an activation signal from the comparator 424.

For example, a process in which the frequency control signal m increases from 0 to 1 will be reviewed. To facilitate understanding, hereinafter, a non-limiting example in which the update signal T_update is 1 and the update step signal T_update_step is set to 1 will be described; the above values may be changed in various ways.

Because the current frequency control signal m is 0, the multiplier 423 outputs 0 to the adder 422, and the adder 422 may add 1, which is an update signal T_update, to 0, and thus, may output 1 to the comparator 424. The counter 425 measures the number of times the second clock signal has elapsed, and if this measured value matches 1, which is the output value of the adder 422, that is, when the cycle of the second clock signal has elapsed once, the comparator 424 may output an active signal to the counter 425. The counter (425) may increase the value of the frequency control signal m from 0 to 1 upon receiving the active signal.

FIG. 9 is a timing diagram showing an example of an operation of generating a clock signal according to an embodiment.

FIG. 9 shows a specific timing diagram corresponding to the example circuit diagram of the droop detection operation shown in FIGS. 5A and 5B and the example circuit diagram of the droop mitigation operation shown in FIGS. 6A and 6B.

A period between the time ‘t11’ and the time ‘t41’ may indicate a state in which no supply voltage droop occurs. In this case, a first clock signal corresponding to the input clock signal CLK_IN may be output as the output clock signal CLK_OUT. Because the supply voltage droop does not occur, the flag signal may indicate no droop detection (e.g., a ‘0’ value), and the output selection signal SEL may maintain an initial value of 0.

A period between ‘t41’ time and ‘t61’ time may indicate a state in which the supply voltage VDD drops sharply, resulting in a supply voltage droop. In the present embodiment, because the delay line 310 (see FIG. 3) is used as a path for the clock signal, when a droop occurs, the propagation delay of the plurality of inverters 313_1 to 313_n (see FIG. 3) included in the delay line 310 (see FIG. 3) increases momentarily, and thus, even before the flag signal FLAG is switched, a clock signal with a lower frequency may be automatically output, thereby effectively preventing a timing violation during the droop detection delay time. In this way, the operation of automatically outputting a clock signal with a lower frequency may be confirmed from the fact that the half clock period of the output clock signal CLK_OUT increases from 78 to 90 in the period between the time ‘t41’ and ‘t51’. In addition, it may also be confirmed that the frequency F_CLKOUT of the output clock signal CLK_OUT is maintained at F_0 in the period between time ‘t11’ and time ‘t31’, and then output at a frequency lower than F_0 in the period between time ‘t31’ and time ‘t41’. Afterwards, in the period between time ‘t51’ and time ‘t61’, the flag signal FLAG may be switched to a state indicating droop detection.

In the period between time ‘t61’ and time ‘t91’, as the flag signal FLAG is switched to a state indicating droop detection, an operation may be exhibited in which a second clock signal having a low target frequency is generated as the output clock signal CLK_OUT to mitigate droop, which may correspond to the operation illustrated in the circuit diagram of FIG. 6A.

A period between the time ‘t61’ and the time ‘t71’ may represent a process in which the shift signal Shift (see FIG. 7) is calculated as 113 and the output selection signal SEL is calculated as 12, and a first rising edge 316b′ of the second clock signal is output from the 13th signal T[12] output from the 13th node of the delay line 310 (see FIG. 3) at the time ‘t71’. A period between the time ‘t71’ and the time ‘t81’ may represent a process in which the shift signal Shift (see FIG. 7) is calculated as 113 and the output selection signal SEL is calculated as 24, and a first falling edge 316c′ of the second clock signal is output from the 25th signal T[24] output from the 25th node of the delay line 310 (see FIG. 3) at the time ‘t81’. A period between the time ‘t81’ and the time ‘t91’ may represent a process in which the shift signal Shift (see FIG. 7) is calculated as 113 and the output selection signal SEL is calculated as 36, and a second rising edge 316d′ of the second clock signal is output from the 37th signal T[36] output from the 37th node of the delay line 310 (see FIG. 3) at the time ‘t91’.

A period between the time ‘t91’ and the time ‘t131’ may represent an operation in which the second clock signal with a target frequency increased stepwise is generated as the output clock signal CLK_OUT in consideration of the droop being alleviated, and this operation may correspond to the operation illustrated in the circuit diagram of FIG. 6B. From the fact that the frequency F_CLKOUT of the output clock signal CLK_OUT increases stepwise in the period between time ‘t91’ and time ‘t131’ compared to the period between time ‘t71’ and time ‘t91’, it may be confirmed that an operation is performed, in which a second clock signal with a target frequency that is increased stepwise is generated as the output clock signal CLK_OUT.

In the period between time ‘t71’ and time ‘t91’, because the second clock signal cycle elapses once and the number of times the second clock signal has elapsed matches 1, which is the update signal T_update (see FIG. 8), the frequency control signal (see FIG. 8) may increase from 0 to 1 from time ‘t91’. Accordingly, the shift signal Shift (see FIG. 7) may decrease from 113 to 105. A period between time ‘t91’ and time ‘t101’ may represent a process in which the shift signal Shift (see FIG. 7) is calculated as 105 and the output selection signal SEL is calculated as 40, and a second falling edge 316e′ of the second clock signal is output from the 41st signal T[40] output from the 41st node of the delay line 310 (see FIG. 3) at time ‘t101’. A period between the time ‘t101’ and the time ‘t111’ may represent a process in which the shift signal Shift (see FIG. 7) is calculated as 105 and the output selection signal SEL is calculated as 44, and a third rising edge 316f of the second clock signal is output from the 45th signal T[44] output from the 45th node of the delay line 310 (see FIG. 3) at the time ‘t111’. A period between the time ‘t111’ and the time ‘t121’ may represent a process in which the shift signal Shift (see FIG. 7) is calculated as 105 and the output selection signal SEL is calculated as 48, and a third falling edge 316g′ of the second clock signal is output from the 49th signal T[48] output from the 49th node of the delay line 310 (see FIG. 3) at the time ‘t121’.

Although a process after the time ‘t131’ is not shown, when the cycle of the second clock signal has passed twice, the number of times the second clock signal has elapsed matches 2, which is a value obtained by adding to a value of 1, which is the update signal T_update (see FIG. 8) a product of a value of 1, which is the update step signal T_update_step (see FIG. 8) and a value of 1, which is the frequency control signal m (see FIGS. 7 and 8), and thus the frequency control signal m (see FIGS. 7 and 8) may increase to 2 from the time ‘t131’. Accordingly, the shift signal Shift (see FIG. 7) may decrease from 105 to 97, and an output selection signal SEL may be generated according to the decreased shift signal Shift (see FIG. 7), and thus, the rising edge and falling edge of the second clock signal may be sequentially generated. In addition, the frequency F_CLKOUT of the output clock signal CLK_OUT output after the time ‘t131’ may be a frequency that is increased stepwise from the interval between the time ‘t91’ and the time ‘t131’.

FIG. 10 is a timing diagram schematically showing the function of the alignment check circuit 430 of FIG. 3 according to an embodiment.

When the droop is mitigated, the second clock signal may need to be converted to an input clock signal CLK_IN having a low jitter characteristic. When switching clock signals, if the phases or periods of two clocks do not match, a glitch may occur, and such a glitch may cause a timing violation. In the prior art, in order to prevent such glitch occurrence, a clock gating method that temporarily blocks the clock signal was used, but there was a problem that a supply voltage overshoot occurred due to a sudden change in current during the process of blocking and then restarting the clock.

Using the alignment check circuit 430 of FIG. 3, when a phase difference between the input clock signal CLK_IN and the second clock signal is less than the range of the second threshold RST_window, that is, the clock signal is switched when the input clock signal CLK_IN and the second clock signal are aligned, thereby preventing the occurrence of glitches and supply voltage overshoot.

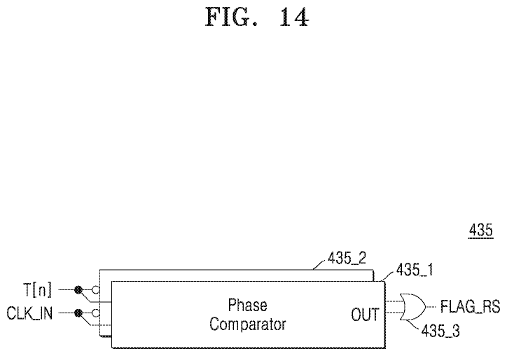

Whether the phase difference between the input clock signal CLK_IN and the second clock signal is less than the range of the second threshold RST_window may be determined by comparing a phase difference between the input clock signal CLK_IN and the n+1-th signal T[n] output from the n+1-th node. Referring to FIG. 3 and FIG. 10, when a flag signal FLAG indicating droop detection (e.g., a value of ‘1’) is switched to a flag signal FLAG indicating droop non-detection (e.g., a value of ‘0’), the input clock signal CLK_IN and the first signal T[0] output from the first node are connected through the tri-state buffer 311, the two signals may need to have to maintain the same polarity to prevent glitch occurrence. In order to ensure that the input clock signal CLK_IN and the first signal T[0] output from the first node maintain the same polarity, it is possible to determine whether the phase difference between the input clock signal CLK_IN and the n+1-th signal T[n] output from the n+1-th node is within the range of the second threshold RST_window, i.e., whether the two signals are aligned. In a cyclic path of the ring oscillator, the n+1 signal T[n] output from the n+1 node is delayed by the clock delay time T_inv of a single inverter and inverted to become the first signal T[0] output from the first node. Therefore, the alignment of the input clock signal CLK_IN and the n+1 signal T[n] output from the n+1 node may be determined using opposite polarities, that is, different types of edges. For example, as in (a) of FIG. 10, the input clock signal CLK_IN may use a rising edge and the n+1 signal T[n] output from the n+1 node may use a falling edge, or as in (b) of FIG. 10, the input clock signal CLK_IN may use a falling edge and the n+1 signal T[n] output from the n+1 node may use a rising edge. If a phase difference between the input clock signal CLK_INT and the n+1-th signal T[n] output from the n+1-th node is within the range of the second threshold RST_window, it may be determined that the two signals are aligned. Because the n+1-th signal T[n] output from the n+1-th node and the first signal T[0] output from the first node have a phase difference equal to a clock delay time T_inv of a single inverter, the second threshold RST_window may be set by considering the phase difference A specific operation of comparing the phase difference between the input clock signal CLK_IN using edge types different from each other and the n+1-th signal T[n] output from the n+1-th node is described later with reference to FIGS. 14 to 16B.

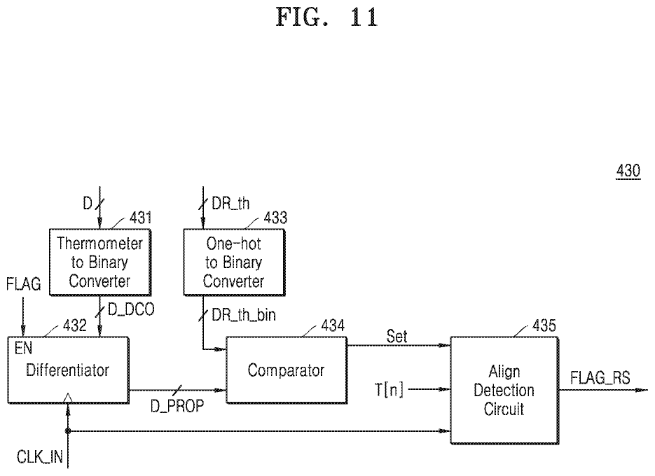

FIG. 11 is a block diagram showing an alignment confirmation circuit of FIG. 3 according to an embodiment.

The alignment check circuit 430 may include a thermometer-to-binary converter 431, a differentiator 432, a one-hot-to-binary converter 433, a comparator 434, and an alignment detection circuit 435.

The alignment check circuit 430 may operate when the flag signal FLAG indicates droop detection. Referring to FIG. 3, when the flag signal FLAG indicates droop detection, the delay line 310 may form a ring oscillator including the plurality of inverters 313_1 to 313_n and the tri-state inverter 312, and a first clock signal may be circulated along a closed loop path of the ring oscillator. At this time, the propagation degree D of the first clock signal, which is a signal captured and output by the plurality of D flip-flops 210 from the first to n+1th signals T[0] to T[n], which are output from the plurality of inverters 313_1 to 313_n and the tri-state inverter 312, may indicate the position (i.e., propagation position) of the inverter at which the first clock signal propagated along the cyclic path of the ring oscillator has reached.

The thermometer-to-binary converter 431 may receive a signal in the form of a thermometer code, convert an index of the bit where the value ‘1’ first appears in the signal into a binary number, and output it. In an embodiment, referring to FIG. 3, the thermometer-to-binary converter 431 may convert the propagation degree D of the first clock signal output from the plurality of D flip-flops 210 into a binary number. Specifically, the thermometer-to-binary converter 431 may convert the propagation degree D of the first clock signal, which indicates the position of the inverter (i.e., the propagation position) reached by the first clock signal propagated along the cyclic path of the ring oscillator, into binary and output the propagation position D_DCO of the first clock signal to the differentiator (432).

The differentiator 432 calculates the number of inverters (i.e., propagation distance) through which the first clock signal circulates during one clock cycle of the input clock signal CLK_IN within the ring oscillator based on the position difference between the propagation position of the first clock signal during the current clock cycle of the input clock signal CLK_IN and the propagation position of the first clock signal during the previous clock cycle of the input clock signal CLK_IN, and then divides the difference in half to output a first clock signal propagation distance D_PROP representing the number of inverters (i.e., propagation distance) through which the first clock signal circulates during the half clock cycle within the ring oscillator to the comparator 434.

The one-hot-to-binary converter 433 may receive a signal in the form of a one-hot code, convert the index of a specific bit in which the value ‘1’ appears in the signal into a binary number, and output it.

In an embodiment, the one-hot-to-binary converter 433 may convert a first threshold DR_th, which may be set as a one-hot code, into binary and output a first threshold DR_th_bin to the comparator 434.

The comparator 434 may compare the first clock signal propagation distance D_PROP with the first threshold DR_th_bin. If the first clock signal propagation distance D_PROP is greater than the first threshold DR_th_bin, it is determined that the supply voltage droop is resolved, and the set signal set may be activated and output to the alignment detection circuit 435.

The alignment detection circuit 435 may be activated when an activated set signal set is input, and may determine whether a phase difference between the input clock signal CLK_IN and the n+1-th signal T[n] output from the n+1-th node is less than the range of the second threshold RST_window. If the phase difference between the input clock signal CLK_IN and the n+1-th signal T[n] output from the n+1-th node is less than the second threshold RST_window range, a reset signal FLAG_RS that resets the flag signal FLAG indicating droop detection to become a flag signal FLAG indicating droop non-detection may be output to the droop detection circuit 200.

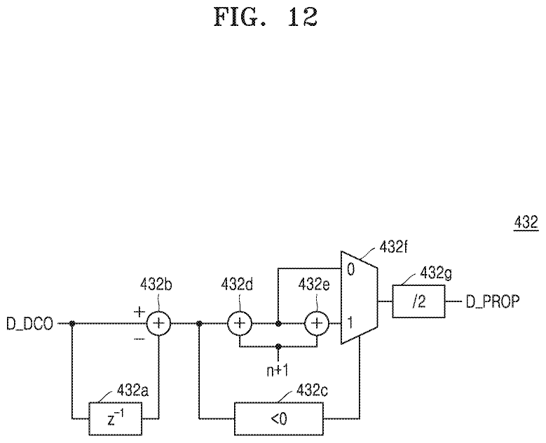

FIG. 12 is a block diagram showing the differentiator 432 of FIG. 11 according to an embodiment.

The differentiator 432 may calculate a first clock signal propagation distance D_PROP that indicates the number of inverters (i.e., propagation distance) through which the first clock signal circulates within the ring oscillator during a half clock period of the input clock signal CLK_IN (see FIG. 11), based on a propagation position D_DCO of the first clock signal.

That is, the differentiator 432 calculates the number of inverters (i.e., propagation distance) through which the first clock signal circulates within the ring oscillator during one clock period of the input clock signal CLK_IN (see FIG. 11) based on a difference between the propagation position of the first clock signal during the current clock period of the input clock signal CLK_IN, FIG. 11 and the propagation position of the first clock signal during the previous clock period of the input clock signal CLK_IN (see FIG. 11), and then divides the difference in half to output the first clock signal propagation distance D_PROP representing the number of inverters (i.e., propagation distance) through which the first clock signal circulates within the ring oscillator during the half clock period to the comparator 434.

The differentiator 432 may include a unit time delay unit 432a, a subtractor 432b, a comparator 432c, an adder 432d, an adder 432e, a multiplexer 432f, and a divider 432g.

The unit time delay unit 432a may output the propagation position of the first clock signal during the previous clock cycle of the input clock signal CLK_IN (see FIG. 11) to the subtractor 432b.

The subtractor 432b may output to the comparator 432c and the adder 432d a value obtained by subtracting an output value of the unit time delay unit 432a from the propagation position D_DCO of the first clock signal. That is, the subtractor 432b may calculate a difference between the propagation position of the first clock signal during the current clock cycle of the input clock signal CLK_IN (see FIG. 11) and the propagation position of the first clock signal during the previous clock cycle of the input clock signal CLK_IN (see FIG. 11).

The comparator 432c may determine whether the output value of the subtractor 432b is negative, and provide a selection signal to the multiplexer 432f. If the output value of the subtractor 432b is not negative, the multiplexer 432f may be controlled to output a first input, and if the output value of the subtractor 432b is negative, the multiplexer 432f may be controlled to output a second input.

The adder 432d may add the total number of inverters n+1 that constitute the ring oscillator to the output value of the subtractor 432b. The adder 432e may additionally add the total number of inverters n+1 that constitute the ring oscillator when the output value of the subtractor 432b is negative. That is, when the output value of the subtractor 432b is not negative, the value obtained by adding the total number of inverters n+1 of the ring oscillator to the output value of the subtractor 432b through the adder 432d may be input as a first input of the multiplexer 431c, and when the output value of the subtractor 432b is negative, the value obtained by adding the total number of inverters n+1 of the ring oscillator twice through the adder 432d and the adder 432e may be input as a second input of the multiplexer 432f.

The reason why the adder 432d adds the total number of inverters n+1 of the ring oscillator to the output value of the subtractor 432b may be to consider that the first clock signal may reach the position after circulating around the ring oscillator more than once when calculating the propagation distance based on the propagation position difference of the first clock signal.

For example, if the propagation position of the first clock signal during the previous clock cycle of the input clock signal CLK_IN (see FIG. 11) is 3, and the propagation position of the first clock signal during the current clock cycle of the input clock signal CLK_IN (see FIG. 11) is 32, the output value of the subtractor 432b may be 29. However, referring to FIG. 5A, because the first clock signal is shown to be propagated to 78 inverters during a half clock period of the input clock signal CLK_IN in normal operation where no supply voltage droop occurs, the calculation result that the first clock signal is propagated to 29 inverters during one clock period of the input clock signal CLK_IN (see FIG. 11) may not match the actual operating characteristics. Therefore, in this case, it may be seen that the first clock signal has circulated through the ring oscillator more than once and reached from propagation position 3 to propagation position 32, and accordingly, the number of inverters through which the first clock signal is propagated during one clock period of the input clock signal CLK_IN (see FIG. 11) may be 130, which is the value added to 101, which is the total number of inverters n+1 constituting the ring oscillator. Considering this, in order to accurately reflect the propagation distance of the first clock signal, the adder 432d may add the total number of inverters n+1 constituting the ring oscillator to the output value of the subtractor 432b.

In the case when the output value of the subtractor 432b is negative, why the adder 432e additionally adds the total number of inverters n+1 constituting the ring oscillator is to compensate for the case when the propagation position difference of the first clock signal is derived as a negative number by considering the cyclic structure of the ring oscillator. For another example, when the propagation position of the first clock signal during the previous clock cycle of the input clock signal CLK_IN is 70 and the propagation position of the first clock signal during the current clock cycle of the input clock signal CLK_IN (see FIG. 11) is 24, the output value of the subtractor 432b may be calculated as −46, which may be a negative number. In this case, considering the cyclic structure of the ring oscillator, if the adder 432e adds 101, which is the total number of inverters n+1 constituting the ring oscillator, 55 may be calculated as the propagation distance. However, as described above, because the first clock signal is shown to be propagated to 78 inverters during a half clock period of the input clock signal CLK_IN (see FIG. 11) in normal operation where no supply voltage droop occurs, it may not be accord with the actual operating characteristics to consider that the first clock signal is propagated to 55 inverters during one clock period of the input clock signal CLK_IN (see FIG. 11). Accordingly, if the adder 432d adds 101, which is the total number of inverters n+1 constituting the ring oscillator, to 55, the number of inverters through which the first clock signal is propagated during one clock period of the input clock signal CLK_IN (see FIG. 11) may be 156.

The multiplexer 432f may select one of the first input or the second input according to the output of the comparator 432c and output the first input or the second input to the divider 432g.

The divider 432g may divide the value output from the multiplexer 432f by 2 and output the first clock signal propagation distance D_PROP. The value output from the multiplexer 432f represents the number of inverters (i.e., propagation distance) through which the first clock signal circulates within the ring oscillator during one clock cycle of the input clock signal CLK_IN (see FIG. 11), and thus, the value may be divided by 2 to use the half clock cycle of the input clock signal CLK_IN (see FIG. 11) as a reference. For example, if the propagation position of the first clock signal during the previous clock cycle of the input clock signal CLK_IN (see FIG. 11) is 3, and the propagation position of the first clock signal during the current clock cycle of the input clock signal CLK_IN (see FIG. 11) is 32, because the propagation position difference is positive, the multiplexer 432f may select a first input, i.e., the corrected value 130 through the adder 432d, and output 130 to the divider 432g. The divider 432g may output 65, which is a value obtained by dividing the value 130 by 2, as the first clock signal propagation distance D_PROP. For another example, if the propagation position of the first clock signal during the previous clock cycle of the input clock signal CLK_IN (see FIG. 11) is 70, and the propagation position of the first clock signal during the current clock cycle of the input clock signal CLK_IN (see FIG. 11) is 24, the position difference is negative, so the multiplexer 432f may select 156, which is the corrected value through the second input, i.e., the adder 432d and the adder 432e, and output the value 156 to the divider 432g. The divider 432g may output 78, which is the value obtained by dividing the value 156 by 2, as the first clock signal propagation distance D_PROP.

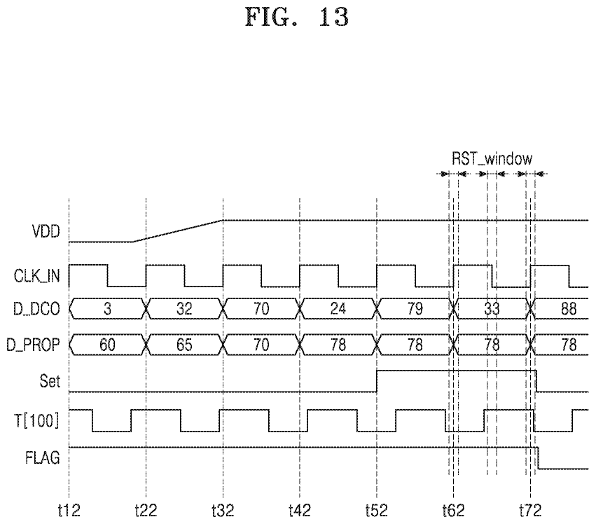

The specific operation of FIG. 12 will be described later in the description of the timing diagram of FIG. 13.

FIG. 13 is a timing diagram specifically showing the operation of FIG. 11 according to an embodiment.

The timing diagram of FIG. 13 may represent an operation of determining whether the supply voltage droop is eliminated in the alignment check circuit 430 (see FIG. 3) of the droop mitigation circuit 400 (see FIG. 3) and determining whether the phase difference between the input clock signal CLK_IN and the n+1^{th} signal (T[n]) output from the n+1^{th} node is within the range of the second threshold RST_window. As an example, n may be 100 in the timing diagram of FIG. 13. The timing diagram of FIG. 13 is described in detail with reference to FIG. 3 and FIG. 11.

The first clock signal propagation distance D_PROP of FIG. 13 may be a value calculated by the differentiator 432 (see FIG. 11) based on a difference between the propagation position D_DCO of the first clock signal during the previous clock cycle of the input clock signal CLK_IN and the propagation position D_DCO of the first clock signal during the current clock cycle of the input clock signal CLK_IN.

The period between the time ‘t12’ and the time ‘t62’ may represent an operation for determining whether the supply voltage droop is eliminated.

In an embodiment, whether the supply voltage droop is mitigated may be determined based on whether the first clock signal propagation distance D_PROP is greater than the first threshold DR_th_bin (see FIG. 11) during two consecutive clock cycles of the input clock signal CLK_IN. If the first clock signal propagation distance D_PROP is greater than the first threshold DR_th_bin (see FIG. 11) during two consecutive clock cycles of the input clock signal CLK_IN, whether the phase difference between the input clock signal CLK_IN and the n+1^{th} signal T[n output from the n+1^{th} node is within the range of the second threshold RST_window may be determined by the alignment detection circuit 435 by activating the set signal Set. As an example, n may be 100, and the first threshold DR_th_bin (see FIG. 11) may be 77. The first clock signal propagation distance D_PROP between the time ‘t42’ and the time ‘t52’ and the first clock signal propagation distance D_PROP between the time ‘t52’ and the time ‘t62’ are 78, which is greater than 77, which is the first threshold DR_th_bin (see FIG. 11), in two consecutive clock cycles of the input clock signal CLK_IN. Therefore, the set signal Set may be activated at the time t5, and it may be determined whether the phase difference between the 101st signal T[100] output from the 101st node and the rising edge and falling edge of the input clock signal CLK_IN from the time t6 is within the range of the second threshold RST_window.

The interval between the time ‘t62’ and the time ‘t72’ may represent an operation for determining whether the phase difference between the input clock signal CLK_IN and the n+1^{th} signal T[n] output from the n+1^{th} node is within the range of the second threshold RST_window. FIG. 13 may represent a state in which a phase difference between the rising edge of the input clock signal CLK_IN and the falling edge of the 101st signal T[100] output from the 101st node at time ‘t72’ is located within the range of the second threshold RST_window. If it is determined that the phase difference between the input clock signal CLK_IN and the 101st signal T[100] output from the 101st node is within the range of the second threshold RST_window, the reset signal FLAG_RS (see FIG. 11) may be activated, and thus, the flag signal FLAG indicating droop detection may be switched to a flag signal FLAG indicating the droop non-detection state. When the flag signal FLAG is switched to a state indicating a droop non-detection state, the operation of the droop mitigation circuit 400 (see FIG. 3) may be deactivated, and the delay line 310 (see FIG. 3) of the clock signal output circuit 300 (see FIG. 3) may operate in a mode for detecting a supply voltage droop.

FIG. 14 is a block diagram illustrating the alignment detection circuit 435 of FIG. 11 according to an embodiment.

The alignment detection circuit 435 may include a plurality of phase comparators 435_1 and 435_2 and an OR gate 435_3. The plurality of phase comparators 435_1 and 435_2 may compare phases between input signals. The plurality of phase comparators 435_1 and 435_2 may be configured in parallel, and outputs of each of the phase comparators (435_1 and 435_2) may be OR-operated in the OR gate 435_3 to be output as a reset signal FLAG_RS. The reset signal FLAG_RS may switch the flag signal FLAG (see FIG. 3) indicating droop detection to the flag signal FLAG (see FIG. 3) indicating droop non-detection.

When the phase difference between the input clock signal CLK_IN and the second clock signal having the target frequency is less than the range of the second threshold RST_window (see FIG. 10), the reset signal FLAG_RS may be output. Whether the phase difference between the input clock signal CLK_IN and the second clock signal is less than the second threshold RST_window (see FIG. 10) range may be determined by comparing whether the phase difference between the input clock signal CLK_IN and the n+1^{th} signal T[n] output from the n+1^{th} node is less than the second threshold RST_window (see FIG. 10). The plurality of phase comparators 435_1 and 435_2 may output a reset signal FLAG_RS that switches the flag signal FLAG (see FIG. 3) indicating droop detection to the droop detection circuit 200 (see FIG. 3) when the phase difference between the input clock signal CLK_IN and the n+1^{th} signal T[n] output from the n+1^{th} node is less than the second threshold RST_window (see FIG. 10).

The phase comparator 435_1 and the phase comparator 435_2 may be configured in parallel, and the phase comparator 435_2 may use a signal that is inverted the input signals of the phase comparator 435_1 as an input signal. For example, the phase comparator 435_1 may compare a phase between the falling edge of the n+1^{th} signal T[n] output from the n+1^{th} node and the rising edge of the input clock signal CLK_IN, and the phase comparator 435_2 may compare a phase between the rising edge of the n+1^{th} signal T[n] output from the n+1^{th} node and the falling edge of the input clock signal CLK_IN. If the phase difference between the input clock signal CLK_IN and the n+1^{th} signal T[n] output from the nn+1^{th} node is minute, the time required to determine whether alignment is achieved may be long, but by configuring the multiple phase comparators 435_1 and 435_2 in parallel, the determination time may be shortened by half. This example is non-limiting, and in another embodiment (not shown), the alignment detection circuit 435 may include one phase comparator 435_1.

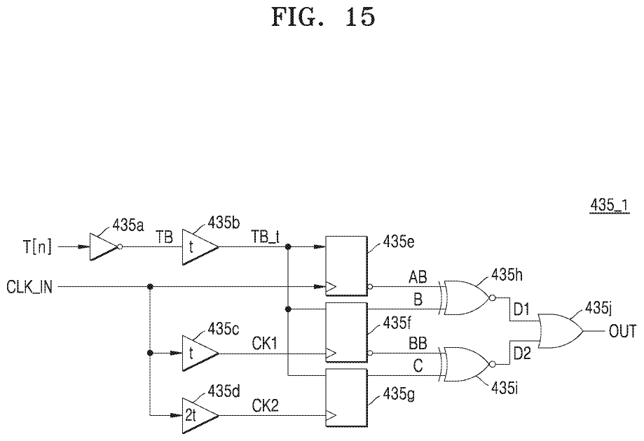

FIG. 15 is a circuit diagram showing the phase comparator 435_1 of FIG. 14 according to an embodiment.

The phase comparator 435_1 may include an inverter 435a, a plurality of delay elements 435b, 435c, and 435d, a plurality of flip-flops 435e, 435f, and 435g, a plurality of XNOR gates 435h and 435i, and an OR gate 435j. However, the phase comparator 435_1 is not limited to the example illustrated in FIG. 15, and the phase comparator 435_1 may be implemented in various ways within the technical scope of the embodiments. The phase comparator 435_2 may be implemented in the same manner as the phase comparator 435_1, or may be implemented in a modified form within the technical scope of the embodiments.

The n+1 signal T[n] output from the n+1 node is inverted by the inverter 435a, delayed by t time by the delay element 435b and may be input as an input signal of multiple flip-flops 435e, 435f, and 435g. The input clock signal CLK_IN is the clock signal of the flip-flop 435e, and after being delayed by t time through the delay element 435c, may be input as a clock signal CK1 of the flip-flop 435f, and after being delayed by 2t time through the delay element 435d, may be input as a clock signal CK2 of the flip-flop 435g. The flip-flop 435e may output a value AB that is an inverted value of the input signal captured at the rising edge of the clock signal, the flip-flop 435f may output a value B that is an inverted value of the input signal captured at the rising edge of the clock signal and a value BB that is an inverted value of the captured value, and the flip-flop 435g may output a value C that is an inverted value of the input signal captured at the rising edge of the clock signal. The outputs of the plurality of flip-flops 435e, 435f, and 435g may be XNOR-operated through the plurality of XNOR gates 435h and 435i. The XNOR gate may output logic high if the two inputs are the same, and logic low if they are different. Afterwards, an OR operation is performed through the OR gate 435j and the output signal OUT of the phase comparator 435_1 may be output.

The second threshold RST_window (see FIG. 10) may be 2t. When the signal OUT output from the OR gate 435j is logic high, it may indicate that the phase difference between the input clock signal CLK_IN and the n+1^{th} signal T[n] output from the n+1^{th} node is less than the range of the second threshold RST_window (see FIG. 10). Conversely, when the signal OUT output from the OR gate 435j is logic low, it may indicate that the phase difference between the input clock signal CLK_IN and the nn+1^{th} signal T[n] output from the n+1^{th} node is greater than or equal to the second threshold RST_window (see FIG. 10).

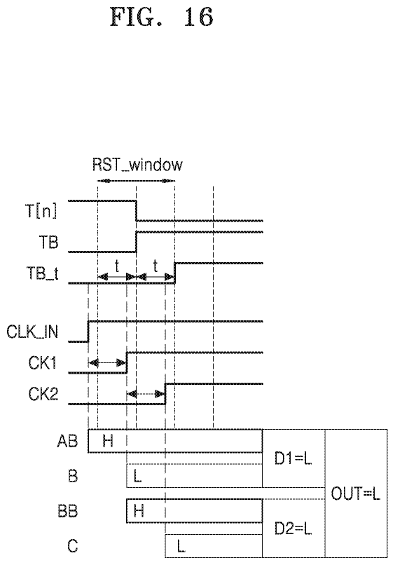

The specific operation of the circuit diagram of FIG. 15 is described in detail in the description of the timing diagrams of FIGS. 16 to 19.

FIGS. 16 to 19 are timing diagrams specifically showing the operation of the phase comparator 435_1 of FIG. 15 according to an embodiment.

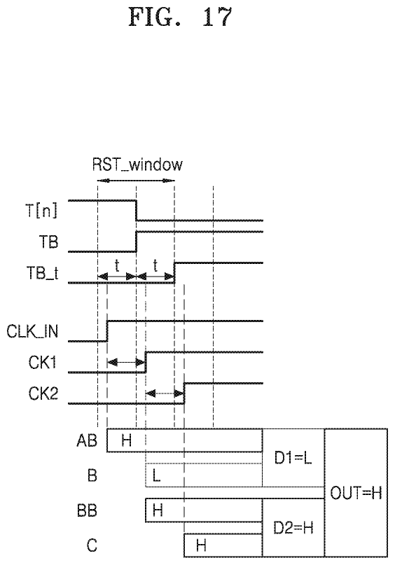

FIGS. 16 and 17 show operations of the phase comparator 435_1 comparing the phase between the falling edge of the n+1^{th} signal T[n] output from the n+1^{th} node and the rising edge of the input clock signal CLK_IN.

Referring to FIG. 16, it can be seen that the phase difference between the rising edge of the input clock signal CLK_IN and the falling edge of the n+1^{th} signal (T[n]) output from the n+1^{th} node is greater than the range of the second threshold RST_window. The flip-flop 435e of FIG. 15 may capture a TB_t signal, which is a logic low, at the rising edge of the input clock signal CLK_IN, and output AB, which is a logic high state that is an inverted TB_t signal. The flip-flop 435f of FIG. 15 may output B in a logic low state by capturing a TB_t signal, which is a logic low, and BB, which is in a logic high state by inverting the B, at the rising edge of the clock signal CK1 which is delayed by t time from an input clock signal CLK_IN. The flip-flop 435g of FIG. 15 may output C in a logic low state by capturing a TB_t signal, which is a logic low, at the rising edge of the clock signal CK2 which is delayed by 2t time from the input clock signal CLK_IN. When AB, which is a logic high, and B, which is a logic low, are XNOR-operated, D1, which is a logic low, may be output, and when BB, which is a logic high, and C, which is a logic low, are XNOR-operated, D2, which is a logic low, may be output. When D1 and D2 are OR-operated, a logic low may be output as an output signal OUT, which may indicate that the phase difference between the input clock signal CLK_IN and the n+1^{th} signal T[n] output from the n+1^{th} node is greater than or equal to the range of the second threshold RST_window.

Referring to FIG. 17, it may be seen that the phase difference between the rising edge of the input clock signal CLK_IN and the falling edge of the n+1^{th} signal T[n] output from the n+1^{th} node is within the range of the second threshold RST_window. The flip-flop 435e of FIG. 15 may capture the TB_t signal, which is a logic low, at the rising edge of the input clock signal CLK_IN, and output AB, which is a logic high state that is inverted TB_t. The flip-flop 435f of FIG. 15 may output B in a logic low state that captures a TB_t signal, which is a logic low, and BB in a logic high state that is inverted B, at the rising edge of the clock signal CK1 which is delayed by t time from the input clock signal CLK_IN. The flip-flop 435g of FIG. 15 may output C in a logic high state that captures a TB_t signal, which is a logic high, at the rising edge of the clock signal CK2 which is delayed by 2t time from the input clock signal (CLK_IN). If AB, which is a logic high, and B, which is a logic low, are XNOR-operated, D1, which is a logic low, may be output, and when BB, which is a logic high, and C, which is a logic high, are XNOR-operated, D2, which is a logic high, may be output. If D1 and D2 are OR-operated, a logic high may be output as an output signal OUT, which may indicate that the phase difference between the input clock signal CLK_IN and the n+1^{th} signal T[n] output from the n+1^{th} node is within the second threshold (RST_window) range.

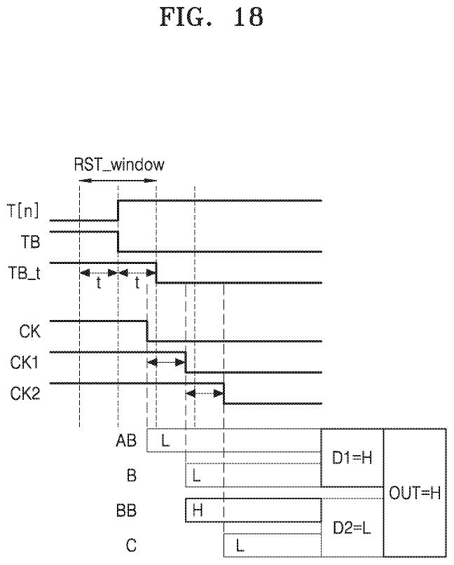

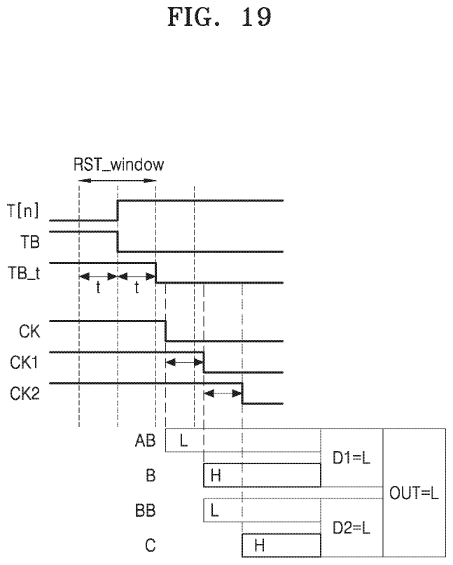

FIGS. 18 and 19 show operations of the phase comparator 435_2 comparing the phase between the rising edge of the n+1^{th} signal T[n] output from the n+1^{th} node and the falling edge of the input clock signal CLK_IN.

Referring to FIG. 18, it may be seen that the phase difference between the falling edge of the input clock signal CLK_IN and the rising edge of the n+1^{th} signal T[n] output from the n+1^{th} node is within the range of the second threshold RST_window. The flip-flop 435e of FIG. 15 may capture the TB_t signal, which is logic high, at the falling edge of the input clock signal CLK_IN, and output AB, which is logic low, which is an inverted state. The flip-flop 435f of FIG. 15 may output B, which is logic low, which captures the TB_t signal, which is logic low, and BB, which is logic high, which is an inverted state, at the falling edge of the clock signal CK1 which is delayed by time t from the input clock signal CLK_IN. The flip-flop 435g of FIG. 15 may output C in a logic low state by capturing the TB_t signal, which is a logic low, at the falling edge of the clock signal CK2 which is delayed by 2t time from the input clock signal CLK_IN. If AB, which is a logic low, and B, which is a logic low, are XNOR-operated, D1, which is a logic high, may be output, and if BB, which is a logic high, and C, which is a logic low, are XNOR-operated, D2, which is a logic low, may be output. If D1 and D2 are OR-operated, a logic high may be output as an output signal OUT, which may indicate that the phase difference between the input clock signal CLK_IN and the n+1^{th} signal T[n] output from the nn+1^{th} node is within the range of the second threshold RST_window.

Referring to FIG. 19, it may be seen that the phase difference between the falling edge of the input clock signal CLK_IN and the falling edge of the n+1^{th} signal (T[n]) output from the n+1^{th} node is greater than or equal to the range of the second threshold RST_window. The flip-flop 435e of FIG. 15 may capture the TB_t signal, which is logic high, at the falling edge of the input clock signal CLK_IN, and output AB, which is logic low, which is the inverted TB_t signal. The flip-flop 435f of FIG. 15 may output B, which is logic high, which captures the TB_t signal, which is logic high, and BB, which is logic low, which is inverted B, at the falling edge of the clock signal CK1 which is delayed by time t from the input clock signal CLK_IN. The flip-flop 435g of FIG. 15 may output C in a logic high state by capturing the TB_t signal, which is logic high, at the falling edge of the clock signal CK2 which is delayed by 2t time from the input clock signal CLK_IN. If AB, which is logic low, and B, which is logic high, are XNOR-operated, D1, which is logic low, may be output, and if BB, which is logic low, and C, which is logic high, are XNOR-operated, D2, which is logic low, may be output. If D1 and D2 are OR-operated, a logic low may be output as an output signal OUT, which may indicate that the phase difference between the input clock signal CLK_IN and the n+1^{th} signal (T[n]) output from the n+1^{th} node is greater than or equal to the range of the second threshold RST_window.

As described above, example embodiments have been disclosed in the drawings and specification. In the present specification, the example embodiments are described by using some specific terms, but the terms used are for description are not intended to be limiting of meanings or the technical scope described in the claims. Therefore, it will be understood by those skilled in the art that various changes in form and details may be made therein without departing from the spirit and scope of the appended claims.

While concepts have been particularly shown and described with reference to embodiments thereof, it will be understood that various changes in form and details may be made therein without departing from the spirit and scope of the following claims.

What is claimed is:

1. A clock supply circuit comprising:
a delay line to which a voltage is supplied from a supply voltage line;
a clock signal output circuit configured to output one of a first clock signal or a second clock signal corresponding to an input clock signal to a device based on a flag signal, wherein the first clock signal having a first frequency and the second clock signal having a second frequency;
a droop detection circuit configured to output the flag signal to the clock signal output circuit, the flag signal indicating whether a droop is detected for the voltage based on a propagation degree of the first clock signal in the delay line; and
a droop mitigation circuit configured to output an output selection signal for the delay line to the clock signal output circuit to control the second frequency of the second clock signal.

2. The clock supply circuit of claim 1, wherein the voltage is provided from the supply voltage line to the device.

3. The clock supply circuit of claim 1, wherein the clock signal output circuit is further configured to:
based on the flag signal indicating that the droop is not detected, output the first clock signal to the device, and
based on the flag signal indicating that the droop is detected, output the second clock signal to the device.

4. The clock supply circuit of claim 1, wherein the second frequency of the second clock signal is lower than the first frequency of the first clock signal.

5. The clock supply circuit of claim 1, wherein the droop detection circuit is further configured to output the flag signal indicating that the droop has occurred based on the propagation degree of the first clock signal being less than or equal to a first threshold.

6. The clock supply circuit of claim 1, wherein the delay line comprises a plurality of inverters connected in series with each other, and
wherein the droop mitigation circuit is further configured to generate the output selection signal for sequentially selecting outputs of the plurality of inverters based on a target frequency for the second clock signal.

7. The clock supply circuit of claim 6, wherein the clock signal output circuit is further configured to generate the second clock signal by selecting at least one of the outputs of the plurality of inverters based on the output selection signal.

8. The clock supply circuit of claim 6, wherein the droop mitigation circuit is further configured to adjust the target frequency to increase stepwise.

9. The clock supply circuit of claim 6, wherein the droop mitigation circuit is further configured to output a reset signal for the flag signal to the droop detection circuit based on the second frequency of the second clock signal reaching the target frequency.

10. The clock supply circuit of claim 6, wherein the droop mitigation circuit is further configured to output a reset signal for the flag signal to the droop detection circuit based on a phase difference between the input clock signal and the second clock signal having the target frequency being less than a second threshold.

11. The clock supply circuit of claim 9, wherein the droop detection circuit is further configured to reset the flag signal based on the reset signal so that the flag signal indicates that the droop has not been detected.

12. A clock supply circuit comprising:
a clock signal output circuit configured to, based on a flag signal having a first value, output an input clock signal that has passed through a delay line, to which voltage is supplied from a supply voltage line, as a first clock signal; and
a droop detection circuit configured to detect a droop in the voltage based on a propagation degree of the first clock signal in the delay line, and to convert the flag signal to a second value,
wherein the clock signal output circuit is further configured to, based on the flag signal having the second value, output a second clock signal generated using the delay line.

13. The clock supply circuit of claim 12, further comprising a droop mitigation circuit configured to control a second frequency of the second clock signal by outputting an output selection signal for the delay line to the clock signal output circuit.

14. The clock supply circuit of claim 12, wherein the delay line comprises a plurality of inverters connected in series with each other, and
wherein the propagation degree of the first clock signal indicates a number of inverters among the plurality of inverters through which the first clock signal is propagated in the delay line.

15. The clock supply circuit of claim 14, wherein the droop detection circuit comprises a plurality of D flip-flops, and
wherein the propagation degree of the first clock signal is based on the plurality of D flip-flops capturing respective outputs of the plurality of inverters.

16. The clock supply circuit of claim 12, wherein the first value indicates that the droop is not detected, and the second value indicates that the droop is detected, and
wherein the droop detection circuit is further configured to output a value of the flag signal by switching from the first value to the second value based on the propagation degree of the first clock signal being less than or equal to a first threshold.

17. A clock supply circuit comprising:
a clock signal output circuit configured to:
based on a flag signal having a first value, output an input clock signal that has passed through a delay line, to which a voltage is supplied from a supply voltage line, as a first clock signal, and
based on the flag signal having a second value, output a second clock signal generated using the delay line, wherein the first clock signal has a first frequency and the second clock signal has a second frequency; and
a droop mitigation circuit configured to output an output selection signal for the delay line to the clock signal output circuit to control the second frequency of the second clock signal to reach a target frequency,
wherein the first value indicates non-detection of a droop of the voltage,
wherein the second value indicates detection of the droop of the voltage, and
wherein the droop mitigation circuit is further configured to switch the flag signal from the second value to the first value based on a phase difference between the input clock signal and the second clock signal having the target frequency being less than a second threshold.

18. The clock supply circuit of claim 17, wherein the delay line comprises a plurality of inverters connected in series with each other, and
wherein the plurality of inverters are further configured to, based on the flag signal having the second value, form a ring oscillator so that the first clock signal is transmitted to the plurality of inverters.

19. The clock supply circuit of claim 17, wherein the delay line comprises a plurality of inverters connected in series with each other,
wherein the droop mitigation circuit is further configured to generate the output selection signal for sequentially selecting outputs of the plurality of inverters based on the target frequency.

20. The clock supply circuit of claim 17, wherein the droop mitigation circuit is further configured to determine that the droop of the voltage has been mitigated based on a propagation distance of the first clock signal being greater than a first threshold during a clock period of the input clock signal.
